(19) United States
(12) Patent Application Publication
(10) Pub. No.: US 2015/0166348 A1
(43) Pub. Date: Jun. 18, 2015

(54) GRAPHENE, GRAPHENE-INCLUDING LAYER, ELECTRODE, AND POWER STORAGE DEVICE

(71) Applicant: SEMICONDUCTOR ENERGY LABORATORY CO., LTD., Atsugi-shi (JP)

(72) Inventors: Tatsuya IKENUMA, Atsugi (JP); Mikio YUKAWA, Atsugi (JP)

(21) Appl. No.: 14/566,954

(22) Filed: Dec. 11, 2014

(30) Foreign Application Priority Data
Dec. 18, 2013 (JP) 2013-261276

(51) Int. Cl. C01B 31/04; H01M 4/58; H01M 4/04; H01M 4/1393; H01G 11/06; H01G 11/32; H01G 11/86; H01M 4/62; H01M 6/00

(52) U.S. Cl. CPC C01B 31/0438; H01M 4/625; H01M 4/5825; C01B 31/0446; H01M 4/049; H01M 4/0471; H01M 4/0404; H01M 6/00; H01G 11/06; H01G 11/32; H01G 11/86; H01M 4/1393

(57) ABSTRACT

Graphene that is formed from graphene oxide and has high conductivity and a method for forming the graphene are provided. A power storage device with high charge discharge capacity and favorable electric properties such as high reliability and high durability and a method for fabricating the power storage device are provided. Chemical reduction and thermal reduction are performed on graphene oxide in this order to form graphene. In the method for fabricating the power storage device including at least a positive electrode, a negative electrode, an electrolytic solution, and a separator, graphene of one or both of a positive electrode and a negative electrode is formed by the forming method of graphene.

### BACKGROUND OF THE INVENTION

1. Field of the Invention

Embodiments of the present invention relate to a forming method of graphene and fabricating methods of an electrode including the graphene and a power storage device including the electrode. Embodiments of the present invention relate to graphene formed by the forming method and an electrode and a power storage device fabricated by the fabricating method. Note that a power storage device in this specification refers to every element and/or device having a function of storing electric power, such as a lithium primary battery, a lithium-ion secondary battery, or a lithium-ion capacitor. Note that one embodiment of the present invention is not limited to the above technical field. The technical field of one embodiment of the invention disclosed in this specification and the like relates to an object, a method, or a fabricating method. In addition, one embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a storage device, a method for driving any of them, and a method for fabricating any of them.

2. Description of the Related Art

Graphene is a carbon material having a crystal structure in which hexagonal skeletons of carbon are spread in a planar form and is one atomic plane extracted from graphite crystals. Due to its excellent electrical property of high conductivity and excellent physical properties of high flexibility and mechanical strength, the graphene has been expected to be used for a variety of products, for example, field-effect transistors with high mobility, highly sensitive sensors, highly-efficient solar cells, and next-generation transparent conductive films.

Application of graphene to power storage devices such as a lithium-ion secondary battery and a lithium-ion capacitor is one of the attempts. For example, an electrode material can be coated with graphene to increase the conductivity of the electrode material for a lithium-ion secondary battery.

As a method for forming graphene, a method of reducing graphite oxide or graphene oxide in the presence of a base is given (see Patent Document 1). For a method of forming graphene by reducing graphene oxide, heat treatment can be employed. [Reference]

### REFERENCE

### [Patent Document 1] Japanese Published Patent Application No. 2011-500488

### SUMMARY OF THE INVENTION

In some cases, the conductivity of graphene formed by reducing graphene oxide depends on the bonding state in the graphene. In some cases, the conductivity of graphene formed by reducing graphene oxide depends on the proportion of carbon atoms, oxygen atoms, or the like in the graphene.

In view of the above, an object of one embodiment of the present invention is to provide graphene that is formed from graphene oxide and has high conductivity and to provide a method for forming the graphene.

An electrode included in a power storage device includes a current collector and an active material layer. In the electrode included in the power storage device, the active material layer includes a conductive additive, binder, and/or the like as well as an active material. For this reason, it is difficult to efficiently increase only the weight of the active material in the electrode included in the power storage device, and thus, it is difficult to increase the charge and discharge capacity per unit weight or volume of the electrode. Furthermore, the electrode included in the power storage device also has a problem in that the binder included in the active material layer swells as it comes into contact with an electrolytic solution, so that the electrode is likely to be deformed and broken.

In view of the above problems, an object of one embodiment of the present invention is to provide a power storage device with high charge and discharge capacity per unit weight or volume of an electrode, high reliability, high durability, and the like and to provide a method for fabricating the power storage device.

Another object of one embodiment of the present invention is to provide a novel material, a novel electrode, a power storage device, or the like. Note that the descriptions of these objects do not disturb the existence of other objects. In one embodiment of the present invention, there is no need to achieve all the objects. Other objects will be apparent from and can be derived from the description of the specification, the drawings, the claims, and the like.

According to one embodiment of the present invention, to reduce graphene oxide, reduction by a chemical reaction using a reducing agent (hereinafter referred to as chemical reduction) and reduction by heat treatment (hereinafter referred to as thermal reduction) are performed in this order, so that graphene is formed.

Note that graphene in this specification refers to single-layer graphene or multilayer graphene including two or more and hundred or less layers. Single-layer graphene refers to a one-atom-thick sheet of carbon molecules having π bonds. Graphene oxide in this specification refers to a substance formed by oxidation of such graphene. Specifically, graphene oxide in this specification refers to graphene in which an epoxy group, a carbonyl group such as a carboxyl group, a hydroxyl group, or the like is bonded to a six-membered ring composed of carbon atoms or a poly-membered rings composed of carbon atoms

One embodiment of the present invention is a method for forming graphene by performing chemical reduction and thermal reduction on graphene oxide in this order. Another embodiment of the present invention is a method for forming a graphene-including layer by forming a graphene oxide-including layer and performing chemical reduction and thermal reduction on the graphene oxide in this order. In the above method, chemical reduction is preferably performed in a polar solvent containing graphene oxide and a reducing agent. In the above method, chemical reduction is preferably performed at a temperature in the range from room temperature to the boiling point of a solvent. In the above method, it is preferred that thermal reduction be performed after chemical reduction is performed and then a drying step is performed. In the above method, thermal reduction is preferably performed at 150° C. or higher under reduced pressure.

With the above method, a power storage device can be fabricated. One embodiment of the present invention is a method for fabricating a power storage device including at least a positive electrode, a negative electrode, an electrolytic solution, and a separator. In the method, a graphene-including active material layer of one or both of the positive electrode and the negative electrode is formed in such a manner that an active material layer including at least an active material and graphene oxide is formed over a current collector and chemical reduction and thermal reduction are performed on the graphene oxide in this order.

In graphene formed by the above method for forming graphene, the proportions of carbon atoms and oxygen atoms measured by X-ray photoelectron spectroscopy (XPS) are greater than or equal to 90 at. % and less than 98 at. % and greater than or equal to 2 at. % and less than 10 at. %, respectively, preferably greater than or equal to 90 at % and less than 95 at. % and greater than or equal to 5 at. % and less than 10 at. %, respectively. Furthermore, in the graphene, the proportion of sp²-bonded carbon atoms of the carbon atoms measured by XPS is 50% to 80% inclusive, preferably 60% to 80% inclusive. That is, in the graphene, the proportion of sp² bonds of carbon atoms of bonds of the carbon atoms measured by XPS is 50% to 80% inclusive, preferably 60% to 80% inclusive.

Graphene formed by the method for forming graphene of one embodiment of the present invention has a resistivity of 3.0×10⁻² Ω·cm or less, preferably 2.0×10⁻² Ω·cm or less, more preferably 1.5×10⁻² Ω·cm or less.

One embodiment of the present invention can provide graphene having higher conductivity than graphene formed by only thermal reduction or chemical reduction and a method for forming the graphene. One embodiment of the present invention can provide a power storage device with increased charge and discharge capacity per unit weight of an electrode and improved reliability and endurance and a method for fabricating the power storage device. One embodiment of the present invention can provide a novel material, a novel electrode, a novel power storage device, or the like. Note that the description of these effects does not disturb the existence of other effects. One embodiment of the present invention does not have to achieve all the objects listed above. Other effects will be apparent from and can be derived from the description of the specification, the drawings, the claims, and the like.

### BRIEF DESCRIPTION OF THE DRAWINGS

In the accompanying drawings:

FIG. 1 shows a method for forming graphene of one embodiment of the present invention;

FIG. 2 shows a method for forming a graphene-including layer of one embodiment of the present invention;

FIGS. 3A and 3B illustrate an electrode of one embodiment of the present invention;

FIGS. 4A and 4B illustrate a coin-type power storage device;

FIGS. 5A and 5B illustrate a cylindrical power storage device;

FIG. 6 illustrates a thin power storage device;

FIGS. 7A and 7B illustrate thin power storage devices;

FIGS. 8A and 8B illustrate a thin power storage device;

FIGS. 9A and 9B illustrate a thin power storage device;

FIGS. 10A to 10C illustrate the radius of curvature of a plane;

FIGS. 11A to 11D illustrate the radius of curvature of a film;

FIGS. 12A to 12C illustrate an example of a power storage device;

FIGS. 13A to 13C illustrate an example of a power storage device;

FIGS. 14A and 14B illustrate an example of a power storage device;

FIGS. 15A1, 15A2, 15B1, and 15B2 illustrate examples of power storage devices;

FIGS. 16A and 16B illustrate examples of power storage devices;

FIGS. 17A to 17G illustrate examples of electronic devices;

FIG. 18 illustrates electronic devices;

FIGS. 19A to 19C illustrate an electronic device;

FIGS. 20A and 20B illustrate an electronic device;

FIG. 21 shows results of the resistivities of electrodes;

FIG. 22 shows the discharge characteristics of a power storage device;

FIG. 23 shows discharge characteristics of a power storage device;

FIG. 24 shows discharge characteristics of a power storage device;

FIG. 25 shows the charge and discharge cycle characteristics of a power storage device;

FIG. 26 shows the discharge characteristics of power storage devices; and

FIG. 27 shows results of the resistivities of electrodes.

### DETAILED DESCRIPTION OF THE INVENTION

Embodiments and examples of the present invention will be described below with reference to the drawings. Note that the present invention is not limited to the description below, and it is easily understood by those skilled in the art that various changes and modifications can be made without departing from the spirit and scope of the present invention. Therefore, the present invention should not be construed as being limited to the following description of the embodiments and the examples. In description with reference to the drawings, in some cases, common reference numerals are used for the same portions in different drawings. Furthermore, in some cases, the same hatch patterns are applied to similar portions, and the similar portions are not necessarily designated by reference numerals.

### Embodiment 1

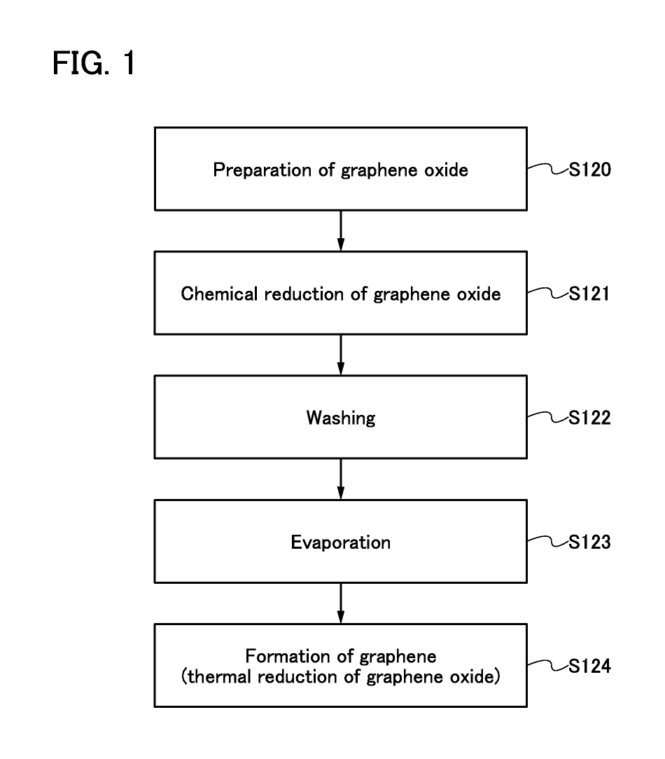

A method for forming graphene of one embodiment of the present invention and the physical properties of graphene formed by the method for forming graphene will be described. FIG. 1 shows steps for forming graphene. In this embodiment, an example of forming graphene will be described.

One embodiment of the present invention is a method for forming graphene by performing chemical reduction and thermal reduction on graphene oxide in this order.

### <Method for Forming Graphene>

### <Step S120>

In Step S120 in FIG. 1, graphene oxide is prepared.

Graphene oxide is a raw material of graphene. Graphene oxide can be formed by various synthesis methods such as a Hummers method, a modified Hummers method, and oxidation of graphite.

For example, in a Hummers method, graphite such as flake graphite is oxidized to give graphite oxide. The obtained graphite oxide is graphite that is oxidized in places and thus to which a functional group such as a carbonyl group, a carboxyl group, or a hydroxyl group is bonded. In the graphite oxide, the crystallinity of the graphite is lost and the distance between layers is increased. Therefore, graphene oxide can be easily obtained by separation of the layers from each other by ultrasonic treatment or the like.

Note that the length of one side (also referred to as a flake size) of graphene oxide can be greater than or equal to 50 nm and less than or equal to 100 μm, preferably greater than or equal to 800 nm and less than or equal to 20 μm.

### <Step S121>

In Step S121 in FIG. 1, graphene oxide and a reducing agent are added to a solvent to cause a chemical reaction, whereby chemical reduction of the graphene oxide is performed. In this step, the graphene oxide is reduced to form a substance 1. The reduction treatment can be performed at a temperature in the range from room temperature to the boiling point of the solvent, for example, at a temperature in the range from room temperature to 150° C. Note that it is possible that oxygen in the graphene oxide not be entirely extracted and partly remain.

The reduction treatment can be performed while graphene oxide is dispersed in a solvent, for example. As a dispersion liquid containing graphene oxide, a commercial product or a dispersion liquid in which graphene oxide formed by the following method is dispersed can be used.

Examples of the reducing agent include L-ascorbic acid, hydrazine, dimethyl hydrazine, hydroquinone, sodium boron hydride (NaBH₄), tetra butyl ammonium bromide (TBAB), LiAlH₄, ethylene glycol, polyethylene glycol, N,N-diethylhydroxylamine, and a derivative thereof. In particular, L-ascorbic acid and hydroquinone are preferable to hydrazine and NaBH₄ in that they are safe due to low reducing ability and utilized industrially with ease.

A polar solvent can be used as the solvent. Any material can be used for the polar solvent as long as it can dissolve the reducing agent. Examples of the material of the polar solvent include water, methanol, ethanol, acetone, tetrahydrofuran (THF), dimethylformamide (DMF), N-methylpyrrolidone (NMP), dimethyl sulfoxide (DMSO), and a mixed solution of any two or more of the above.

### <Step S122>

Next, in Step S122 in FIG. 1, the substance 1 is collected from the dispersion liquid and washed. The substance 1 can be collected by centrifugation or filtration, for example. The substance 1 can be washed using any of the polar solvents given in Step S121.

### <Step S123>

Then, the substance 1 is dried in Step S123 in FIG. 1. The drying of the substance 1 can be performed by ventilation drying, vacuum drying, or the like at room temperature or higher. For example, the drying of the substance 1 can be performed using hot air at 50° C. or higher. In this step, the solvent used in Step S121 can be evaporated. Note that there is no particular limitation on an atmosphere. Note that “vacuum” refers to the state of a space filled with a gas with a pressure lower than an atmospheric pressure.

### <Step S124>

Then, in Step S124 in FIG. 1, heat treatment is performed so that the substance 1 is thermally reduced. The heat treatment (thermal reduction) can be performed at 150° C. or higher in vacuum, for example. The substance 1 is reduced to form a substance 2 through the two steps of S121 and S124. The substance 2 is graphene of one embodiment of the present invention.

Through the above steps, the graphene can be formed.

In the graphene formed by the method for forming graphene of one embodiment of the present invention, the proportions of carbon atoms and oxygen atoms measured by XPS are, for example, greater than or equal to 90 at. % and less than 98 at. % and greater than or equal to 2 at. % and less than 10 at. %, respectively, preferably greater than or equal to 90 at. % and less than 95 at. % and greater than or equal to 5 at. % and less than 10 at. %, respectively. Furthermore, in the graphene, the proportion of sp²-bonded carbon atoms of the carbon atoms measured by XPS is, for example, 50% to 80% inclusive, preferably 60% to 80% inclusive. That is, in the graphene, the proportion of sp² bonds of carbon atoms of bonds of the carbon atoms measured by XPS is, for example, 50% to 80% inclusive, preferably 60% to 80% inclusive.

Graphene formed by the method for forming graphene of one embodiment of the present invention has a resistivity of, for example, 3.0×10⁻² Ω·cm or less, preferably 2.0×10⁻² Ω·cm or less, more preferably 1.5×10⁻² Ω·cm or less.

Examples of methods for reducing graphene oxide include a method of causing reduction by releasing oxygen atoms in graphene oxide mainly as carbon dioxide by only thermal reduction and a method of causing a chemical reaction with the use of a reducing agent by only chemical reduction. Graphene of one embodiment of the present invention, which is obtained by performing chemical reduction and thermal reduction in this order, is different from graphene formed by only thermal reduction or chemical reduction in at least the following points. The graphene of one embodiment of the present invention contains a higher proportion of carbon atoms measured by XRP than graphene formed by only chemical reduction. Furthermore, the graphene of one embodiment of the present invention contains a higher proportion of sp²-bonded carbon atoms than graphene formed by only thermal reduction. Furthermore, the graphene of one embodiment of the present invention has a lower resistivity than graphene formed by only thermal reduction or chemical reduction. In other words, the graphene of one embodiment of the present invention has a higher conductivity than graphene formed by only thermal reduction or chemical reduction.

According to this embodiment, graphene that has higher conductivity than graphene formed by only thermal reduction or chemical reduction can be formed.

Note that one embodiment of the present invention is not limited thereto. For example, the order or the number of times of thermal reduction, chemical reduction, and/or the like can be changed depending on the case or according to the circumstance.

This embodiment can be implemented in appropriate combination with any of the other embodiments and examples.

### Embodiment 2

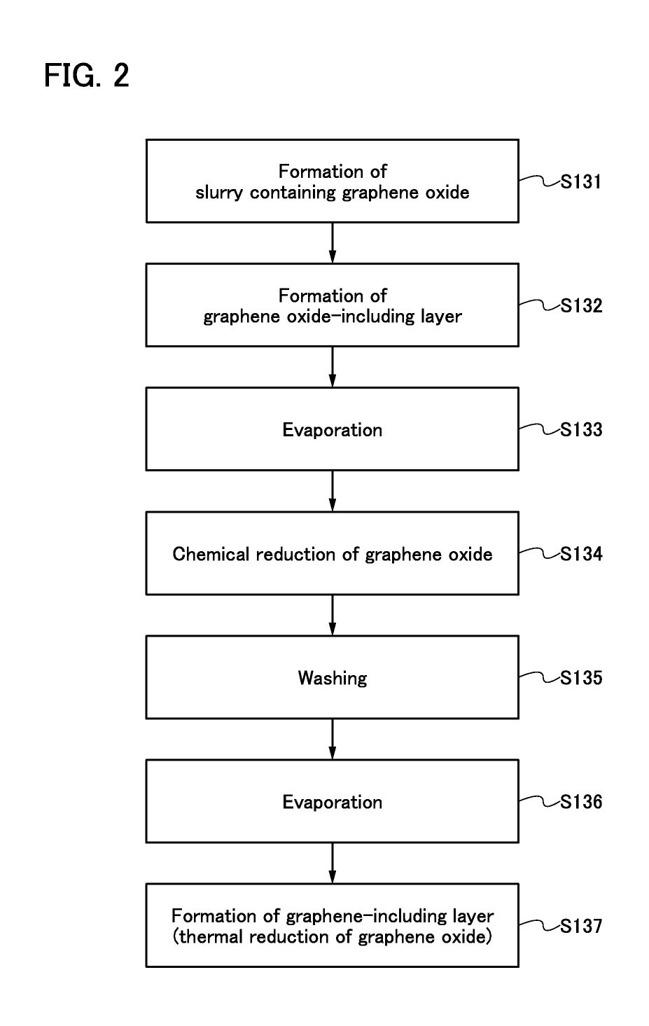

A method for forming a graphene-including layer of one embodiment of the present invention and the physical properties of a graphene-including layer formed by the method will be described. FIG. 2 shows steps for forming a graphene-including layer. In this embodiment, an example of forming a graphene-including layer from a graphene oxide-including layer will be described.

One embodiment of the present invention is a method for forming a graphene-including layer by performing chemical reduction and thermal reduction on a graphene oxide-including layer in this order.

### <Method for Forming Graphene-Including Layer>

### <Step S131>

Slurry containing graphene oxide is formed in Step S131 in FIG. 2. The “slurry” refers to a suspension in which a material and a solvent are mixed. For example, in the case where a graphene-including layer is used for a positive electrode or a negative electrode of a power storage device, the slurry can contain an active material, a solvent, and the like in addition to the graphene oxide. The slurry can further contain binder. The slurry can be formed by mixing the graphene oxide, the active material, the solvent, and the like. Graphene oxide with high dispersibility is mixed with the active material and the like, whereby slurry in which the active material and the graphene oxide are evenly dispersed can be formed.

A polar solvent can be used as the solvent. Examples of the material of the polar solvent include water, methanol, ethanol, acetone, tetrahydrofuran (THF), dimethylformamide (DMF), N-methylpyrrolidone (NMP), dimethyl sulfoxide (DMSO), and a mixed solution of any two or more of the above.

Graphene oxide as a raw material of graphene. Graphene oxide can be formed by various synthesis methods such as a Hummers method, a modified Hummers method, and oxidation of graphite.

For example, in a Hummers method, graphite such as flake graphite is oxidized to give graphite oxide. The obtained graphite oxide is graphite that is oxidized in places and thus to which a functional group such as a carbonyl group, a carboxyl group, or a hydroxyl group is bonded. In the graphite oxide, the crystallinity of the graphite is lost and the distance between layers is increased. Therefore, graphene oxide can be easily obtained by separation of the layers from each other by ultrasonic treatment or the like. Note that the length of one side (also referred to as a flake size) of graphene oxide that is formed is preferably several micrometers to several tens of micrometers.

The length of one side (also referred to as a flake size) of the graphene oxide is greater than or equal to 50 nm and less than or equal to 100 μm, preferably greater than or equal to 800 nm and less than or equal to 20 μm.

Note that the amount of graphene oxide is set to 0.1 wt % to 10 wt % inclusive, preferably 0.1 wt % to 5 wt % inclusive, more preferably 0.2 wt % to 1 wt % inclusive with respect to the total weight of the mixture of the graphene oxide, the active material, the binder, and the like. In contrast, the graphene obtained after reduction is performed is included at least at 0.05 wt % to 5 wt % inclusive, preferably 0.05 wt % to 2.5 wt % inclusive, more preferably 0.1 wt % to 0.5 wt % inclusive with respect to the total weight of the graphene-including layer. This is because the weight of graphene obtained by reducing graphene oxide is approximately half that of the graphene oxide.

Note that a polar solvent may be further added after the mixing so that the viscosity of the mixture can be adjusted. Mixing and addition of a polar solvent may be performed multiple times.

### <Step S132>

Next, a graphene oxide-including layer is formed using the slurry in Step S132 in FIG. 2. A graphene-including layer can be formed over any of an insulator, a semiconductor, and a conductor. For example, in the case where the graphene-including layer is used for a positive electrode or a negative electrode of a power storage device, the graphene oxide-including layer can be formed over a current collector. In the case where the graphene-including layer is used for an electrode of a semiconductor device, the graphene oxide-including layer can be formed over a substrate, an insulating layer, a semiconductor layer, or a conductive layer.

The graphene oxide-including layer can be formed by a coating method, a spin coating method, a dip coating method, a spray coating method, or the like. An example of the coating method is the doctor blade method. Alternatively, these methods may be combined as appropriate to be employed. For example, after a graphene oxide-including layer is formed by a dip coating method, the graphene oxide-including layer is rotated by a method similar to a spin coating method, so that the evenness of the thickness of the graphene oxide-including layer can be improved.

### <Step S133>

Then, the graphene oxide-including layer is dried in Step S133 in FIG. 2. The drying of the graphene oxide-including layer can be performed by ventilation drying, vacuum drying, or the like at room temperature or higher. In this step, the solvent used in Steps S131 and S132 can be evaporated. Note that there is no particular limitation on an atmosphere.

### <Step S134>

In Step S134 in FIG. 2, the graphene oxide-including layer is soaked in a solvent and a reducing agent is added to the solvent to cause a chemical reaction, whereby chemical reduction of the graphene oxide is performed. In this step, the graphene oxide is reduced to form a substance 3. The reduction treatment can be performed at a temperature in the range from room temperature to the boiling point of the solvent, for example, at a temperature in the range from room temperature to 150° C. Note that it is possible that oxygen in the graphene oxide not be entirely extracted and partly remain.

Examples of the reducing agent include L-ascorbic acid, hydrazine, dimethyl hydrazine, hydroquinone, sodium boron hydride (NaBH₄), tetra butyl ammonium bromide (TBAB), LiAlH₄, ethylene glycol, polyethylene glycol, N,N-diethylhydroxylamine, and a derivative thereof. In particular, L-ascorbic acid and hydroquinone are preferable to hydrazine and NaBH₄ in that they are safe due to low reducing ability and utilized industrially with ease.

A polar solvent can be used as the solvent. Any material can be used for the polar solvent as long as it can dissolve the reducing agent. Examples of the material of the polar solvent include water, methanol, ethanol, acetone, tetrahydrofuran (THF), dimethylformamide (DMF), N-methylpyrrolidone (NMP), dimethyl sulfoxide (DMSO), and a mixed solution of any two or more of the above.

### <Step S135>

Next, in Step S135 in FIG. 2, the layer including the substance 3 obtained in Step S134 is washed. The layer including the substance 3 can be washed using any of the polar solvents given in Step S134.

### <Step S136>

Then, the layer including the substance 3 is dried in Step S136 in FIG. 2. The drying of the layer including the substance 3 can be performed by ventilation drying, vacuum drying, or the like at room temperature or higher. For example, the drying of the layer including the substance 3 can be performed using hot air at 50° C. or higher. In this step, the solvent used in Steps S134 and S135 can be evaporated. Note that there is no particular limitation on an atmosphere.

### <Step S137>

Then, in Step S137 in FIG. 2, heat treatment is performed so that the substance 3 is thermally reduced. The heat treatment (thermal reduction) can be performed at 150° C. or higher in vacuum, for example. Through the two steps of S134 and S137, the substance 3 is reduced to form a substance 4, so that a layer including the substance 4 is formed. The substance 4 is graphene of one embodiment of the present invention.

Through the above steps, a graphene-including layer can be formed.

In the graphene formed by the method for forming graphene of one embodiment of the present invention, the proportions of carbon atoms and oxygen atoms measured by XPS are, for example, greater than or equal to 90 at. % and less than 98 at. % and greater than or equal to 2 at. % and less than 10 at. %, respectively, preferably greater than or equal to 90 at. % and less than 95 at. % and greater than or equal to 5 at. % and less than 10 at. %, respectively. Furthermore, in the graphene, the proportion of sp²-bonded carbon atoms of the carbon atoms measured by XPS is, for example, 50% to 80% inclusive, preferably 60% to 80% inclusive. That is, in the graphene, the proportion of sp² bonds of carbon atoms of bonds of the carbon atoms measured by XPS is, for example, 50% to 80% inclusive, preferably 60% to 80% inclusive.

Graphene formed by the method for forming graphene of one embodiment of the present invention has a resistivity of, for example, 3.0×10⁻² Ω·cm or less, preferably 2.0×10⁻² Ω·cm or less, more preferably 1.5×10⁻² Ω·cm or less.

The graphene-including layer formed by the forming method of one embodiment of the present invention that includes graphene at least at 0.05 wt % to 5 wt % inclusive, preferably 0.05 wt % to 2.5 wt % inclusive, more preferably 0.1 wt % to 0.5 wt % inclusive with respect to the total weight of the graphene-including layer can be used. Furthermore, the graphene-including layer has a resistivity of, for example, 1.0×10² Ω·cm or less, preferably 5.0×10¹ Ω·cm or less.

Examples of methods for reducing graphene oxide include a method of causing reduction by releasing oxygen atoms in graphene oxide mainly as carbon dioxide by only thermal reduction and a method of causing a chemical reaction with the use of a reducing agent by only chemical reduction. Graphene of one embodiment of the present invention, which is obtained by performing chemical reduction and thermal reduction in this order, is different from graphene formed by only thermal reduction or chemical reduction in at least the following points. The graphene of one embodiment of the present invention contains a higher proportion of carbon atoms measured by XRP than graphene formed by only chemical reduction. Furthermore, the graphene of one embodiment of the present invention contains a higher proportion of sp²-bonded carbon atoms than graphene formed by only thermal reduction. Furthermore, the graphene of one embodiment of the present invention has a lower resistivity than graphene formed by only thermal reduction or chemical reduction. In other words, the graphene of one embodiment of the present invention has a higher conductivity than graphene formed by only thermal reduction or chemical reduction.

According to this embodiment, graphene that has higher conductivity than graphene formed by only thermal reduction or chemical reduction can be formed.

This embodiment can be implemented in appropriate combination with any of the structures described in the other embodiments and examples.

### Embodiment 3

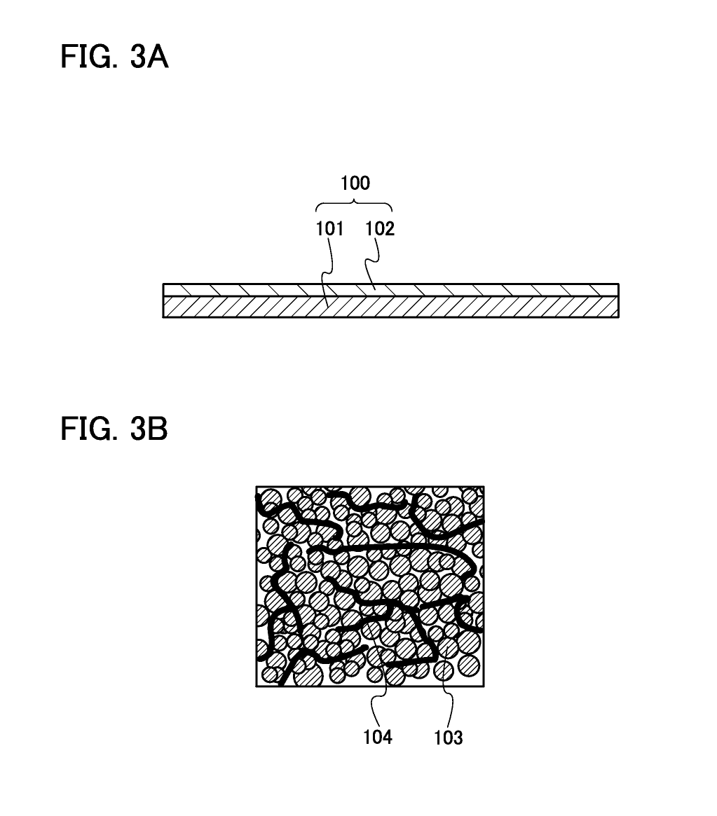

In this embodiment, an electrode of one embodiment of the present invention will be described with reference to FIGS. 3A and 3B. Specifically, an electrode fabricated using the method for forming graphene that is described in Embodiment 1 or the method for forming a graphene-including layer that is described in Embodiment 2 will be described.

In this embodiment, an example of using the electrode of one embodiment of the present invention as one or both of a positive electrode and a negative electrode of a power storage device will be described. Specifically, an electrode (a positive electrode or a negative electrode) fabricated using a method for forming a graphene-including active material layer by forming an active material layer including an active material and graphene oxide over a current collector and performing chemical reduction and thermal reduction on the graphene oxide in this order will be described.

FIG. 3A is a cross-sectional view of an electrode 100, which is a positive electrode or a negative electrode of a power storage device. In the electrode 100, an active material layer 102 is formed over a current collector 101. FIG. 3B is a cross-sectional view of part of the active material layer 102. The active material layer 102 includes at least an active material particles 103 and graphene 104 and may further include binder (not illustrated) or the like.

Note that an active material refers to a material that relates to insertion and extraction of ions serving as carriers (hereinafter referred to as carrier ions) in a power storage device. Thus, the active material and the active material layer are distinguished.

There is no particular limitation on the current collector 101 as long as a material thereof has high conductivity without causing a chemical change in the power storage device. The current collector 101 can be formed using a highly conductive material that is not alloyed with a carrier ion of lithium or the like, such as a metal typified by stainless steel, gold, platinum, zinc, iron, nickel, copper, aluminum, titanium, tantalum, or manganese, an alloy thereof, or sintered carbon. Alternatively, the metal, the alloy, sintered carbon, or the like that is coated with nickel, titanium, or the like can be used to form the current collector 101. Alternatively, an aluminum alloy to which an element that improves heat resistance, such as silicon, titanium, neodymium, scandium, and molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The current collector 101 can be made in any of various forms including a film, a sheet, a foil, a net, a porous structure, and a non-woven fabric. The current collector 101 can have a foil-like shape, a plate-like shape (sheet-like shape), a net-like shape, a cylindrical shape, a coil shape, a punching-metal shape, an expanded-metal shape, or the like as appropriate. The current collector 101 may be formed to have micro irregularities on the surface thereof in order to enhance adhesion to the active material layer, for example. The current collector 101 preferably has a thickness of 5 μm to 30 μm, inclusive.

When the electrode 100 is formed to be used as a positive electrode, a material into and from which lithium ions can be intercalated and deintercalated can be used for the active material particles 103; for example, a material with an olivine crystal structure, a layered rock-salt crystal structure, a NASICON crystal structure, or a spinel crystal structure can be used. For the active material particles 103, a compound such as LiFeO₂, LiCoO₂, LiNiO₂, LiMn₂O₄, V₂O₅, Cr₂O₅, or MnO₂ can be used.

Typical examples of the material with an olivine crystal structure (LiMPO₄ (general formula) (M is one or more of Fe(II), Mn(II), Co(II), and Ni(II))) are lithium metal phosphate compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCO_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

LiFePO₄ is particularly preferable because it properly has properties necessary for the positive electrode active material, such as safety, stability, high capacity density, high potential, and the existence of lithium ions which can be extracted in initial oxidation (charge).

Examples of a material with a layered rock-salt crystal structure include lithium cobalt oxide (LiCoO₂), lithium nickel oxide (LiNiO₂), LiMnO₂, Li₂MnO₃, a NiCo-containing material (general formula: LiNiₓCo₁₋ₓO₂ (0<x<1)) such as LiNi_{0.8}Co_{0.2}O₂, a NiMn-containing material (general formula: LiNiₓMn₁₋ₓO₂ (0<x<1)) such as LiNi_{0.5}Mn_{0.5}O₂, a NiMnCo-containing material (also referred to as NMC) (general formula: LiNiₓMn_{y}Co_{1-x-y}O₂ (x>0, y>0, x+y<1)) such as LiNi_{1/3}Mn_{1/3}Co_{1/3}O₂. Moreover, Li(Ni_{0.8}Co_{0.15}Al_{0.05})O₂, Li₂MnO₃—LiMO₂ (M=Co, Ni, or Mn), and the like can be given as the examples.

Examples of a material with a spinel crystal structure include LiMn₂O₄, Li₁₊ₓMn₂₋ₓO₄, and LiMn_{1.5}Ni_{0.5}O₄.

It is preferred that a small amount of lithium nickel oxide (LiNiO₂ or LiNi₁₋ₓMO₂ (M=Co, Al, or the like)) be added to a material with a spinel crystal structure that contains manganese, such as LiMn₂O₄, in which case advantages such as inhibition of the elution of manganese and the decomposition of an electrolytic solution can be obtained.

Alternatively, a lithium metal silicate compound such as Li₍₂₋ⱼ₎MSiO₄ (general formula) (M is one or more of Fe(II), Mn(II), Co(II), and Ni(II); 0≦j≦2) may be used as the active material particles 103. Typical examples of the general formula Li₍₂₋ⱼ₎MSiO₄ which can be used as a material are lithium metal compounds such as Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Still alternatively, a NASICON compound expressed by AₓM₂(XO₄)₃ (general formula) (A=Li, Na, or Mg, M=Fe, Mn, Ti, V, Nb, or Al, X═S, P, Mo, W, As, or Si) can be used for the active material particles 103. Examples of the NASICON compound are Fe₂(MnO₄)₃, Fe₂(SO₄)₃, and Li₃Fe₂(PO₄)₃. Further alternatively, a compound expressed by Li₂MPO₄F, Li₂MP₂O₂, or Li₅MO₄ (general formula) (M=Fe or Mn), a perovskite fluoride such as NaF₃ and FeF₃, a metal chalcogenide (a sulfide, a selenide, or a telluride) such as TiS₂ and MoS₂, a material with an inverse spinel structure such as LiMVO₄, a vanadium oxide (V₂O₅, V₆O₁₃, LiV₃O₈, or the like), a manganese oxide, an organic sulfur compound, or the like can be used as the positive electrode active material.

In the case where carrier ions are alkali metal ions other than lithium ions, or alkaline-earth metal ions, a material containing an alkali metal (e.g., sodium and potassium) or an alkaline-earth metal (e.g., calcium, strontium, barium, beryllium, and magnesium) instead of lithium may be used as the positive electrode active material.

When the electrode 100 is formed to be used as a negative electrode, a material capable of being oxidized and reduced by carrier ions can be used for the active material particles 103. In the case where carrier ions are lithium ions, a material with which lithium can be dissolved and precipitated or a material into and from which lithium ions can be intercalated and deintercalated can be used; for example, a lithium metal, a carbon-based material, an alloy-based material, or the like can be used.

The lithium metal is preferable because of its low redox potential (3.045 V lower than that of a standard hydrogen electrode) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, graphene, carbon black, and the like.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (0.1 V to 0.3 V vs. Li/Li⁺) when lithium ions are intercalated into a gap between layers of the graphite (while a lithium-graphite intercalation compound is formed). For this reason, a lithium-ion secondary battery can have a high operating voltage. In addition, graphite is preferable because of its advantages such as relatively high capacity per unit volume, small volume expansion, low cost, and safety greater than that of a lithium metal.

For the active material particles 103, an alloy-based material may be used. Here, an alloy-based material refers to a material which enables charge-discharge reactions by an alloying reaction and a dealloying reaction with carrier ions. In the case where carrier ions are lithium ions, a material containing at least one of Al, Si, Ge, Sn, Pb, Sb, Bi, Ag, Au, Zn, Cd, In, Ga, and the like can be used, for example. In particular, silicon has a significantly high theoretical capacity of 4200 mAh/g and thus is preferably used. For example, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn, can be used.

Alternatively, for the active material particles 103, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the active material particles 103, Li₃₋ₓMₓN (M=Co, Ni, or Cu) with a Li₃N structure, which is a nitride containing lithium and a transition metal, can be used. For example, Li_{2.6}Cu_{0.4}N₃ is preferable because of high charge and discharge capacity (900 mAh/g and 1890 mAh/cm³).

A nitride containing lithium and a transition metal is preferably used, in which case lithium ions are contained in the negative electrode active materials and thus the negative electrode active materials can be used in combination with a material for a positive electrode active material which does not contain lithium ions, such as V₂O₅ or Cr₃O₈. In the case of using a material containing lithium ions as a positive electrode active material, the nitride containing lithium and a transition metal can be used for the negative electrode active material by extracting the lithium ions contained in the positive electrode active material in advance.

Alternatively, a material which causes a conversion reaction can be used for the active material particles 103; for example, a transition metal oxide which does not cause an alloy reaction with lithium, such as cobalt oxide (CoO), nickel oxide (NiO), and iron oxide (FeO), may be used as a negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as a positive electrode active material because of its high potential.

The active material layer 102 may be predoped with lithium in such a manner that, for example, a lithium layer is formed on a surface of the active material layer 102 by a sputtering method. Alternatively, lithium foil is provided on the surface of the active material layer 102, whereby the active material layer 102 can be predoped with lithium.

In the case of using the electrode 100 as one or both of a positive electrode and a negative electrode, a material into and from which carrier ions such as lithium ions can be intercalated and deintercalated is used for the active material particles 103 as described above. The active material particles 103 can be particles with an average diameter or diameter distribution, which are obtained in such a way that material compounds are mixed at a predetermined ratio and baked and the resulting baked product is crushed, granulated, and classified by an appropriate means. Therefore, the active material particles 103 are schematically illustrated as spheres in FIG. 3B; however, the shape of the active material particles 103 is not limited to this shape.

The average diameter of the active material particles 103 is greater than or equal to 50 nm and less than or equal to 500 nm, preferably greater than or equal to 20 nm and less than or equal to 100 nm. Note that the diameter of the active material particle 103 is preferably smaller such that the surface area of the active material particles 103 is increased and the distance of electrons (and carrier ions) movement is shortened, because electrons (and carrier ions) move in the active material layer 102.

Sufficient characteristics of a power storage device can be obtained even when surfaces of the active material particles 103 are each not coated with a carbon film; however, it is preferred that both the graphene and the active material coated with a carbon film be used because current flows between the active material particles 103 by hopping conduction.

The desired thickness of the active material layer 102 is determined in the range from 20 μm to 100 mm. Note that the thickness of the positive electrode active material layer 102 is preferably adjusted as appropriate so that a crack and separation are not caused.

The active material layer 102 may contain any of various conductive additives such as acetylene black particles having a volume 0.1 to 10 times as large as that of the graphene, and any of carbon particles having a one-dimensional expansion (e.g., carbon nanofibers), and/or any of various types of binder such as polyvinylidene difluoride (PVDF).

Examples of the binder include polyimide, polytetrafluoroethylene, polyvinyl chloride, an ethylene-propylene-diene polymer, styrene-butadiene rubber, acrylonitrile-butadiene rubber, fluorine rubber, polyvinyl acetate, polymethyl methacrylate, polyethylene, nitrocellulose, and the like, in addition to polyvinylidene fluoride (PVDF), which is a typical example.

FIG. 3B is a cross-sectional view of part of the active material layer 102. The active material layer 102 in FIG. 3B includes the active material particles 103 and graphene 104. FIG. 3B shows substantially uniform dispersion of the sheet-like graphenes 104 in the active material layer 102. The graphenes 104 are schematically shown by heavy lines in FIG. 3B but are actually thin films each having a thickness corresponding to the thickness of a single layer or a multiple layer of carbon molecules. The plurality of graphenes 104 are formed in such a way as to wrap, coat, or be adhered to a plurality of the active material particles 103, so that the graphenes 104 make surface contact with the active material particles 103. Further, the graphenes 104 are also in surface contact with each other; consequently, the plurality of graphenes 104 form a three-dimensional network for electric conduction.

This is because graphene oxides with extremely high dispersibility in a polar solvent are used for formation of the graphenes 104. The solvent is removed by volatilization from a dispersion medium containing the graphene oxides uniformly dispersed and the graphene oxides are reduced to give graphenes; hence, the graphenes 104 remaining in the active material layer 102 partly overlap with each other and are dispersed such that surface contact is made, thereby forming a path for electric conduction.

Unlike a conductive additive in the form of particles, such as acetylene black, which makes point contact with an active material, the graphenes 104 are capable of surface contact with low contact resistance; accordingly, the electric conduction of the active material particles 103 and the graphenes 104 can be improved without an increase in the amount of a conductive additive. Thus, the proportion of the active material particles 103 in the active material layer 102 can be increased. Accordingly, the discharge capacity of a power storage device can be increased.

Examples of the active material include a material whose volume is increased by reception of carrier ions. When such a material is used as the active material, the active material layer gets vulnerable and is partly collapsed by charge and discharge, resulting in lower reliability (e.g., inferior cycle characteristics) of a power storage device. However, the graphene 104 covering part or the whole of the periphery of the active material particles 103 in the electrode in the power storage device of one embodiment of the present invention can prevent the active material particles 103 from being pulverized and can prevent the active material layer 102 from being collapsed, even when the volume of the active material particles 103 is increased/decreased by charge/discharge. That is to say, the graphene 104 included in the electrode in the power storage device of one embodiment of the present invention has a function of maintaining the bond between the active material particles 103 even when the volume of the active material particles 103 is increased/decreased by charge/discharge. Thus, the use of the electrode 100 allows improvement in durability of the power storage device.

Furthermore, binder does not have to be used in forming the active material layer 102. Therefore, the proportion of the active material in the active material layer with certain weight can be increased, leading to an increase in charge and discharge capacity per unit weight of the electrode.

The graphene 104 has conductivity and is in contact with a plurality of the active material particles 103; thus, it also serves as a conductive additive. For this reason, a conductive additive does not have to be used in forming the negative electrode active material layer 102. Therefore, the proportion of the active materials in the active material layer 102 with certain weight (certain volume) can be increased, leading to an increase in charge and discharge capacity per unit weight (unit volume) of the electrode.

Furthermore, the graphene 104 is graphene of one embodiment of the present invention. That is, the graphene 104 is obtained by performing chemical reduction and thermal reduction in this order as described in Embodiments 1 and 2, and has higher conductivity than graphene formed by only thermal reduction or chemical reduction. A sufficient conductive path (conductive path of carrier ions) is formed efficiently in the active material layer 102, so that the active material layer 102 and the electrode 100 have high conductivity. The capacity of the active material particles 103 in the power storage device including the electrode 100, which is comparable to the theoretical capacity, can thus be utilized efficiently, leading to a significant increase in the discharge capacity.

In the case of using the electrode 100 as a negative electrode, the graphene 104 also functions as a negative electrode active material capable of receiving and releasing carrier ions, leading to an increase in charge capacity of the electrode 100.

Next, a method for fabricating the electrode 100 will be described.

Slurry containing the active material particles 103 and graphene oxide is formed. Here, an example of forming the slurry will be described. A necessary amount of solvent for forming a paste is added to a mixture of the graphene oxide and the active material particles, and mixing is performed in a mixer. Then, the obtained paste is kneaded. Here, kneading refers to mixing something in a highly viscous state like a paste state. The kneading may be performed several times. The kneading can weaken cohesion of graphene oxide and the active material, uniformly dispersing the graphene oxide and the active material.

Next, binder may be added to the mixture. In that case, it is preferred that mixing be performed several times and the binder be added in several parts.

Then, the solvent is added to the mixture until the mixture has desired viscosity and the solvent and the mixture are mixed; thus, the slurry can be formed.

After the current collector 101 is coated with the slurry, drying is performed for a certain period of time to remove the solvent from the slurry coating the current collector 101. Note that at that time, molding may be performed by applying pressure as needed.

After that, the active material layer 102 including graphene is formed by performing chemical reduction and thermal reduction on graphene oxide in this order in a manner similar to that of the method for forming a graphene-including layer that is described in Embodiment 2. For the details, refer to Embodiment 2 as appropriate. Through the above process, the active material layer 102 can be formed over the current collector 101, whereby the electrode 100 can be fabricated.

When the electrode 100 is fabricated, the graphene oxide is negatively charged in a polar solvent because the graphene oxide contains oxygen. As a result of being negatively charged, the graphene oxide is dispersed. The active material particles 103 contained in the slurry are thus not easily aggregated, so that the size of the active material particle 103 can be prevented from increasing in the fabricating process of the electrode 100. Consequently, it is possible to prevent increase in internal resistance and the movement of electrons (and carrier ions) in the active material particles 103 is easy, leading to high conductivity of the active material layer 102 and the electrode 100.

According to this embodiment, an electrode including graphene having higher conductivity than graphene formed by performing only thermal reduction or thermal reduction can be fabricated.

This embodiment can be implemented in appropriate combination with any of the other embodiments and examples.

### Embodiment 4

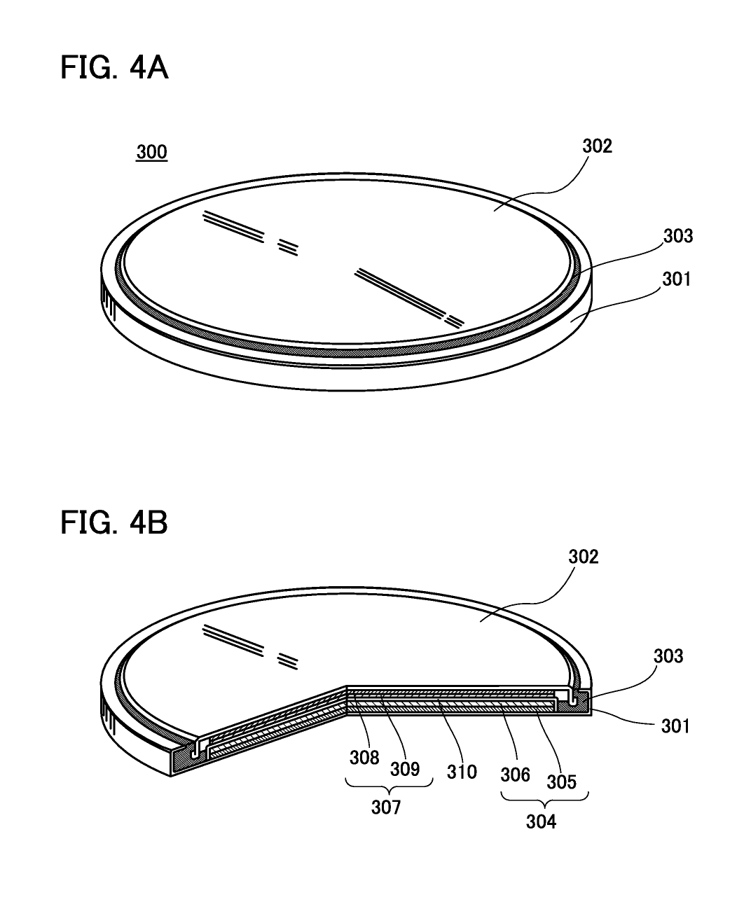

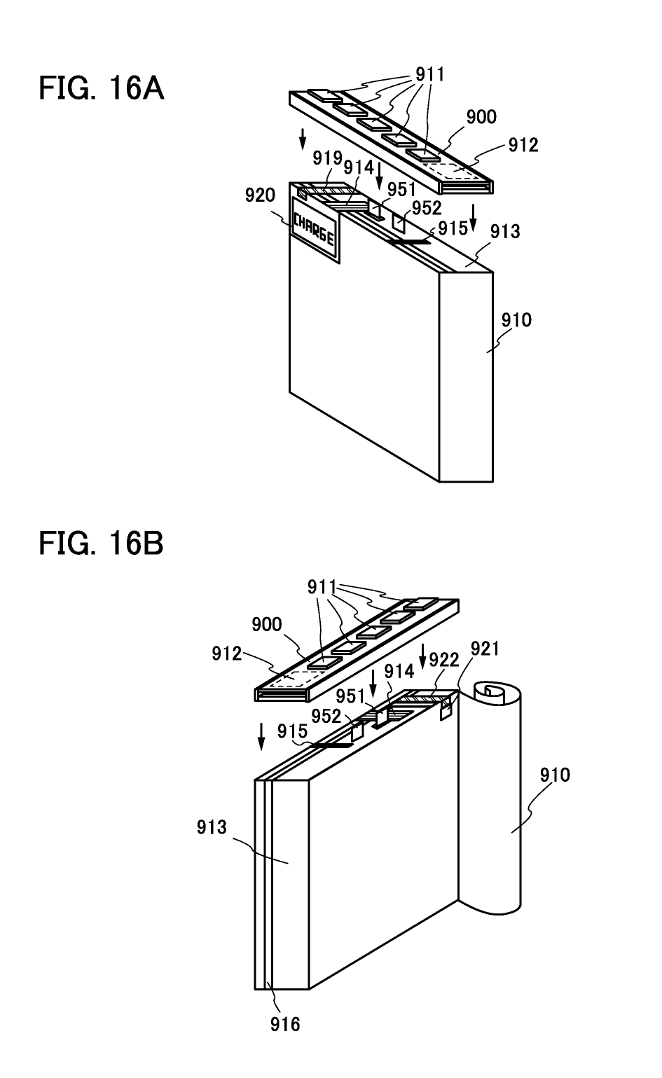

In this embodiment, the structure of a power storage device using an electrode for a power storage device that is fabricated by the fabricating method described in Embodiment 3 will be described with reference to FIGS. 4A and 4B, FIGS. 5A and 5B, FIG. 6, FIGS. 7A and 7B, FIGS. 8A and 8B, FIGS. 9A and 9B, FIGS. 10A to 10C, FIGS. 11A to 11D, FIGS. 12A to 12C, FIGS. 13A to 13C, FIGS. 14A and 14B, FIGS. 15A1 to 15B2, and FIG. 16.

### (Coin-Type Power Storage Device)

FIG. 4A is an external view of a coin-type (single-layer flat type) power storage device, and FIG. 4B is a cross-sectional view thereof.

In a coin-type power storage device 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. A separator 310 and an electrolytic solution (not illustrated) are provided between the positive electrode active material layer 306 and the negative electrode active material layer 309.

As one or both of the positive electrode 304 and the negative electrode 307, an electrode for a power storage device that is fabricated by the method for fabricating a power storage device of one embodiment of the present invention described in Embodiment 3 can be used.

In the case where the electrode for a power storage device of one embodiment of the present invention is used as one of the positive electrode 304 and the negative electrode 307, graphene is not necessarily used for the other. In that case, the other electrode can include a conductive additive such as carbon particles (e.g., carbon black or carbon nanofibers), and the active material, binder, and the like described in Embodiment 3. In the case where graphene is not used, the form of the active material is not particularly limited to the form of particles.

As the separator 310, an insulator such as cellulose (paper), polyethylene, and polypropylene with pores can be used.

As an electrolyte of an electrolytic solution, a material which contains carrier ions is used. Typical examples of the electrolyte are lithium salts such as LiPF₆, LiClO₄, LiAsF₆, LiBF₄, LiCF₃SO₃, Li(CF₃SO₂)₂N, and Li(C₂F₅SO₂)₂N. One of these electrolytes may be used alone, or two or more of them may be used in an appropriate combination and in an appropriate ratio.

Note that when carrier ions are alkali metal ions other than lithium ions, or alkaline-earth metal ions, a material containing an alkali metal (e.g., sodium and potassium), an alkaline-earth metal (e.g., calcium, strontium, barium, beryllium, and magnesium) for the electrolyte, instead of lithium in the above lithium salts.

As a solvent of the electrolytic solution, a material with the carrier ion mobility is used. As the solvent of the electrolytic solution, an aprotic organic solvent is preferably used. Typical examples of aprotic organic solvents include EC, propylene carbonate, dimethyl carbonate, DEC, γ-butyrolactone, acetonitrile, dimethoxyethane, tetrahydrofuran, and the like, and one or more of these materials can be used. When a gelled high-molecular material is used as the solvent of the electrolytic solution, safety against liquid leakage and the like is improved. Furthermore, the power storage device can be thinner and more lightweight. Typical examples of gelled high-molecular materials include a silicone gel, an acrylic gel, an acrylonitrile gel, polyethylene oxide, polypropylene oxide, a fluorine-based polymer, and the like. Alternatively, the use of one or more kinds of ionic liquids (room temperature molten salts) which have features of non-flammability and non-volatility as a solvent of the electrolytic solution can prevent the power storage device from exploding or catching fire even when the power storage device internally shorts out or the internal temperature increases owing to overcharging and others.

Instead of the electrolytic solution, a solid electrolyte including an inorganic material such as a sulfide-based inorganic material or an oxide-based inorganic material, or a solid electrolyte including a macromolecular material such as a polyethylene oxide (PEO)-based macromolecular material may alternatively be used. When the solid electrolyte is used, a separator and a spacer are not necessary. Furthermore, the battery can be entirely solidified; therefore, there is no possibility of liquid leakage and thus the safety of the battery is dramatically increased.

For the positive electrode can 301 and the negative electrode can 302, a metal having a corrosion-resistant property to a liquid such as an electrolytic solution in charging and discharging the power storage device, such as nickel, aluminum, or titanium, an alloy of such a metal, an alloy of such a metal and another metal (e.g., stainless steel or the like), a stack of such metals, a stack of such a metal and such an alloy (e.g., a stack of stainless steel and aluminum), or a stack including such a metal and another metal (e.g., a stack of nickel, iron, and nickel) can be used. The positive electrode can 301 and the negative electrode can 302 are electrically connected to the positive electrode 304 and the negative electrode 307, respectively.

The negative electrode 307, the positive electrode 304, and the separator 310 are soaked in the electrolytic solution. Then, as illustrated in FIG. 4B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 interposed therebetween. In such a manner, the coin-type power storage device 300 can be manufactured.

### [Cylindrical Power Storage Device]

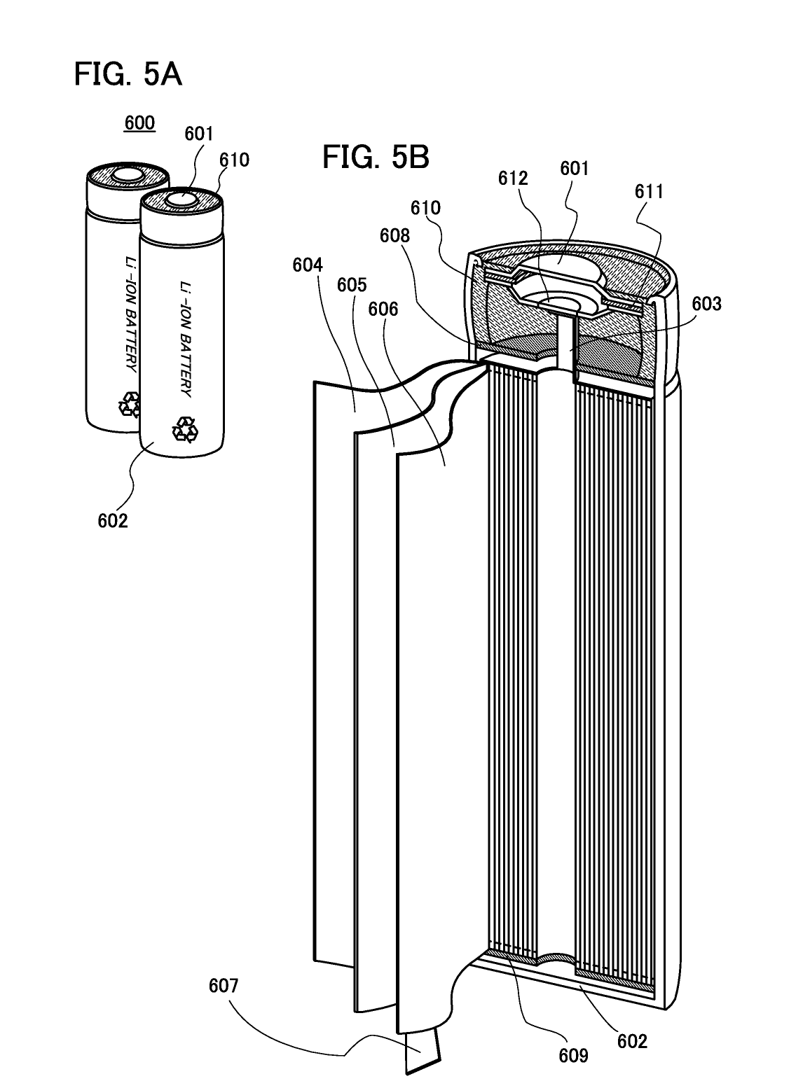

Next, an example of a cylindrical power storage device will be described with reference to FIGS. 5A and 5B. As illustrated in FIG. 5A, a cylindrical power storage device 600 includes a positive electrode cap (battery cap) 601 on the top surface and a battery can (outer can) 602 on the side surface and bottom surface. The positive electrode cap 601 and the battery can 602 are insulated from each other by a gasket (insulating gasket) 610.

FIG. 5B is a diagram schematically illustrating a cross section of the cylindrical power storage device. Inside the battery can 602 having a hollow cylindrical shape, a battery element in which a strip-like positive electrode 604 and a strip-like negative electrode 606 are wound with a stripe-like separator 605 interposed therebetween is provided. Although not illustrated, the battery element is wound around a center pin. One end of the battery can 602 is close and the other end thereof is open. For the battery can 602, a metal having a corrosion-resistant property to a liquid such as an electrolytic solution in charging and discharging the power storage device, such as nickel, aluminum, or titanium, an alloy of such a metal, an alloy of such a metal and another metal (e.g., stainless steel or the like), a stack of such metals, a stack of such a metal and such an alloy (e.g., a stack of stainless steel and aluminum), or a stack including such a metal and another metal (e.g., a stack of nickel, iron, and nickel) can be used. Inside the battery can 602, the battery element in which the positive electrode, the negative electrode, and the separator are wound is provided between a pair of insulating plates 608 and 609 which face each other. Furthermore, a nonaqueous electrolytic solution (not illustrated) is injected inside the battery can 602 provided with the battery element. As the nonaqueous electrolytic solution, a nonaqueous electrolytic solution that is similar to those of the coin-type power storage device can be used.

As one or both of the positive electrode 604 and the negative electrode 606, an electrode for a power storage device that is fabricated by the method for fabricating an electrode for a power storage device of one embodiment of the present invention, which is described in Embodiment 3, can be used.

Although the positive electrode 604 and the negative electrode 606 can be formed in a manner similar to that of the positive electrode and the negative electrode of the coin-type power storage device described above, the difference lies in that, since the positive electrode and the negative electrode of the cylindrical power storage device are wound, active materials are formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Note that barium titanate (BaTiO₃)-based semiconductor ceramic can be used for the PTC element.

### (Thin Power Storage Device)

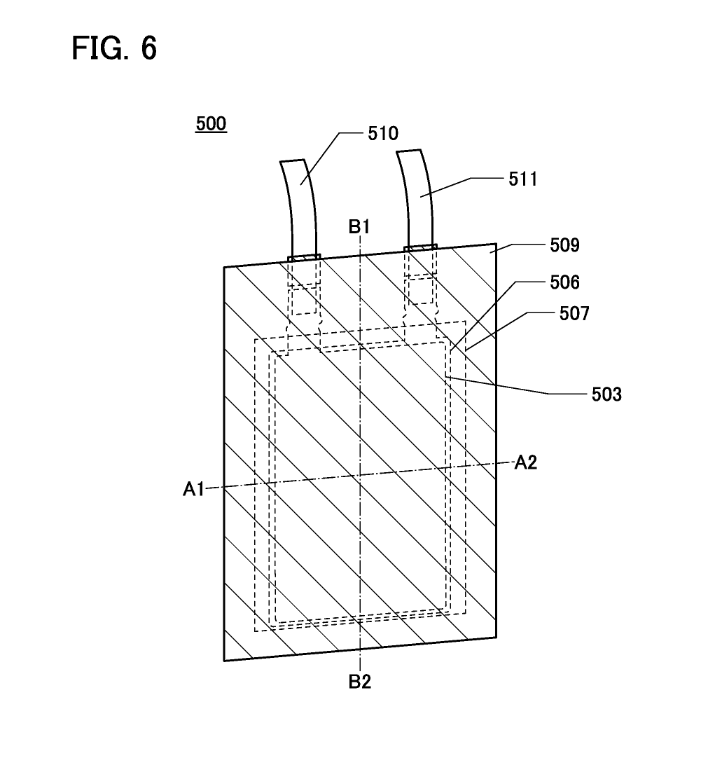

Next, an example of a thin power storage device will be described with reference to FIG. 6. When the thin power storage device is flexible and is used in an electronic device at least part of which is flexible, the power storage device can be bent as the electronic device is bent.

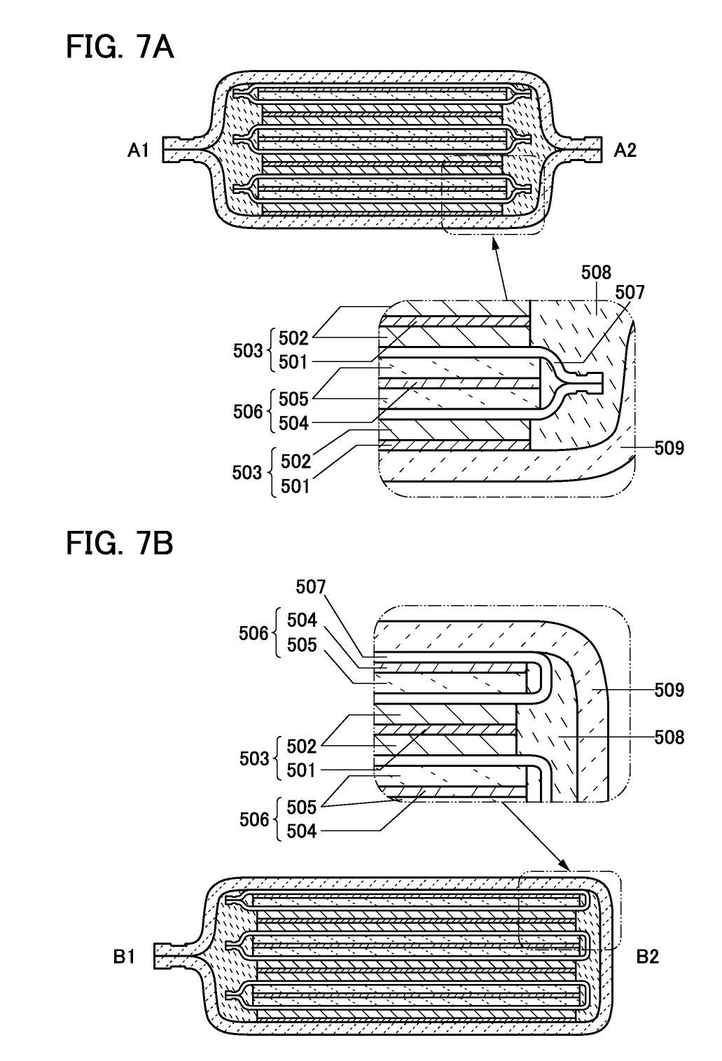

FIG. 6 is an external view of a thin power storage device 500. FIG. 7A is a cross-sectional view along dashed-dotted line A1-A2 in FIG. 6, and FIG. 7B is a cross-sectional view along dashed-dotted line B1-B2 in FIG. 6. The thin power storage device 500 includes a positive electrode 503 including a positive electrode current collector 501 and a positive electrode active material layer 502, a negative electrode 506 including a negative electrode current collector 504 and a negative electrode active material layer 505, a separator 507, an electrolytic solution 508, and an exterior body 509. The separator 507 is provided between the positive electrode 503 and the negative electrode 506 in the exterior body 509. The electrolytic solution 508 is included in the exterior body 509.

As one or both of the positive electrode 503 and the negative electrode 506, an electrode for a power storage device that is fabricated by the method for fabricating an electrode for a power storage device of one embodiment of the present invention, which is described in Embodiment 3, can be used.

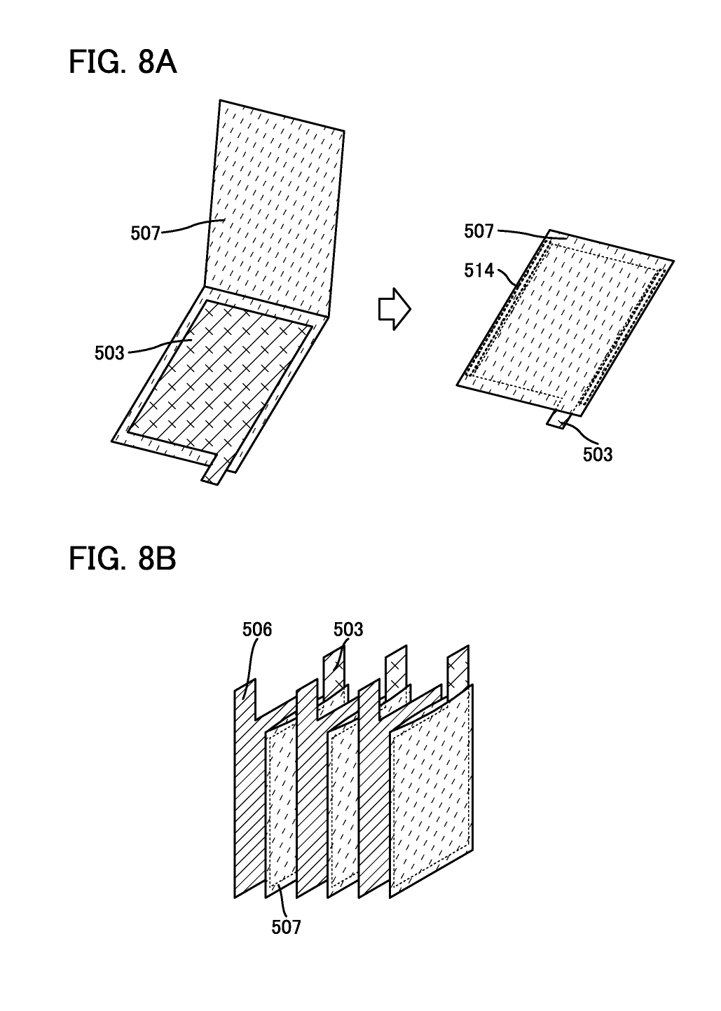

The separator 507 is preferably formed to have a bag-like shape to surround one of the positive electrode 503 and the negative electrode 506. For example, as illustrated in FIG. 8A, the separator 507 is folded in two so that the positive electrode 503 is sandwiched, and sealed with a sealing member 514 in a region outside the region overlapping with the positive electrode 503; thus, the positive electrode 503 can be reliably supported inside the separator 507. Then, as illustrated in FIG. 8B, the positive electrodes 503 surrounded by the separators 507 and the negative electrodes 506 are alternately stacked and provided in the exterior body 509, whereby the thin power storage device 500 can be formed.

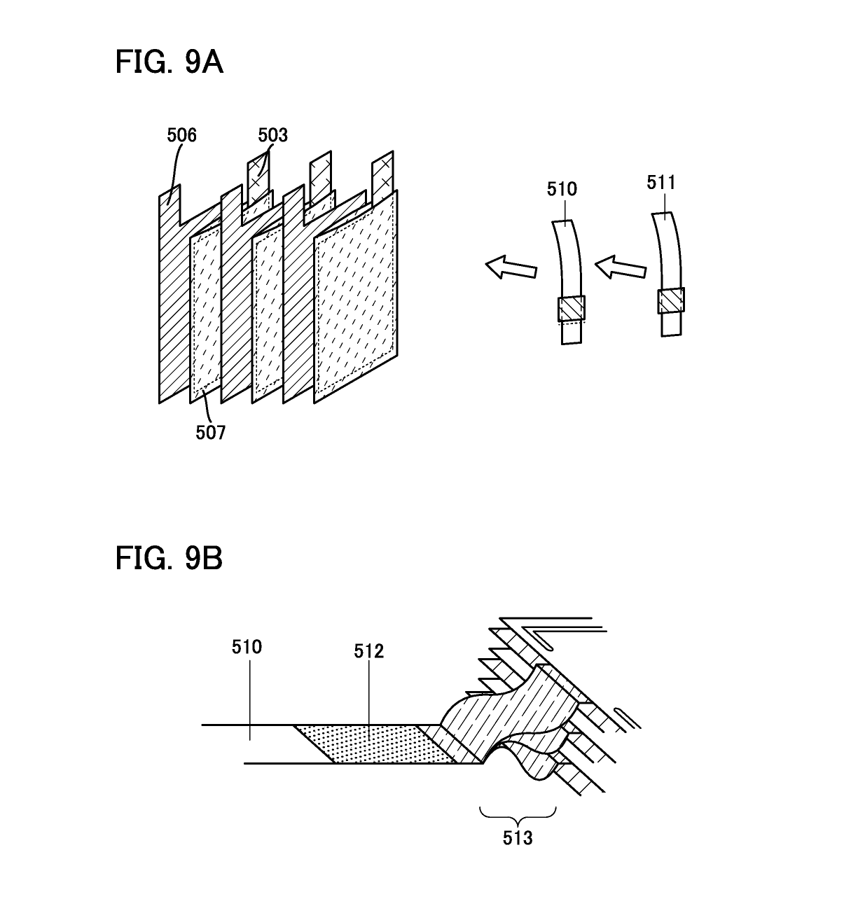

FIG. 9B illustrates an example where a current collector is welded to a lead electrode, specifically, an example where positive electrode current collectors 501 are welded to a positive electrode lead electrode 510. The positive electrode current collectors 501 are welded to the positive electrode lead electrode 510 in a welding region 512 by ultrasonic welding or the like. The positive electrode current collector 501 includes a bent portion 513 as illustrated in FIG. 9B, and it is therefore possible to relieve stress due to external force applied after fabrication of the power storage device 500. Thus, the power storage device 500 can have high reliability.

In the thin power storage device 500 illustrated in FIG. 6 and FIGS. 7A and 7B, the positive electrode current collectors 501 and the negative electrode current collectors 504 are welded to the positive electrode lead electrode 510 and a negative electrode lead electrode 511, respectively, by ultrasonic welding so that part of the positive electrode lead electrode 510 and part of the negative electrode lead electrode 511 are exposed to the outside. The positive electrode current collector 501 and the negative electrode current collector 504 can double as terminals for electrical contact with the outside. In that case, the positive electrode current collector 501 and the negative electrode current collector 504 may be arranged so that part of the positive electrode current collector 501 and part of the negative electrode current collector 504 are exposed to the outside the exterior body 509 without using lead electrodes.

As the exterior body 509 in the thin power storage device 500, for example, a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used.

The example in FIG. 6 includes 3 electrode layers. It is needless to say that the number of electrode layers is not limited to 3, and may be more than 3 or less than 3. In the case of using a large number of electrode layers, the power storage device can have high capacity. In contrast, in the case of using a small number of electrode layers, the power storage device can have a small thickness and high flexibility.

In the above structure, the exterior body 509 of the power storage device can change its form with a radius of greater than or equal to 10 mm, preferably greater than or equal to 30 mm. One or two films are used as the exterior body of the power storage device. In the case where the power storage device has a layered structure, the power storage device has a cross section sandwiched by two curved surfaces of the films when it is bent.

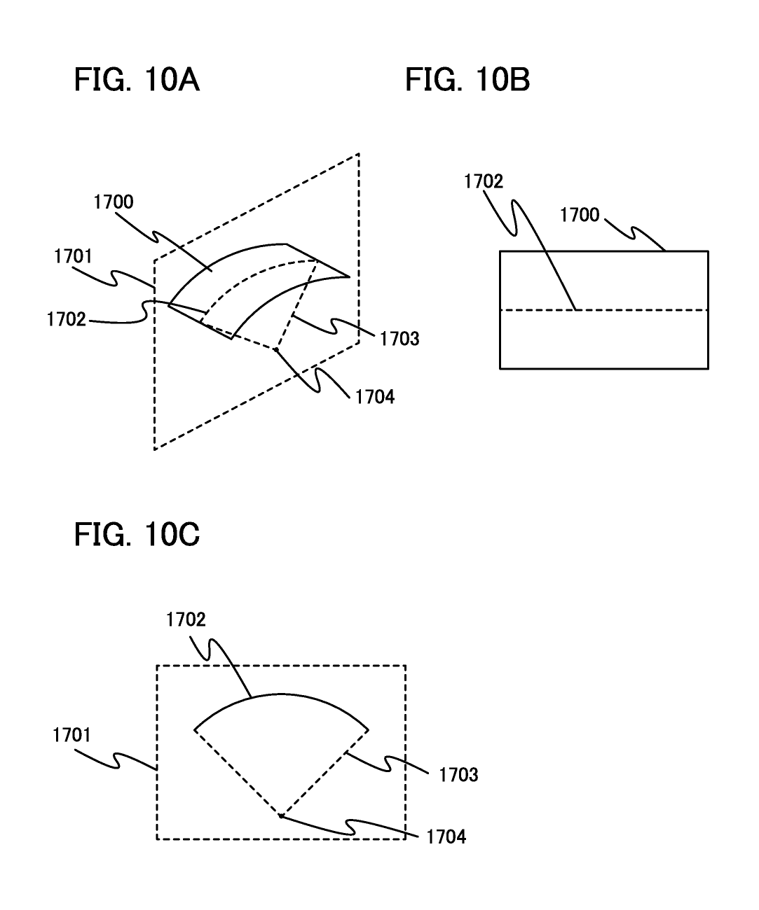

A description is given of the radius of curvature of a surface with reference to FIGS. 10A to 10C. In FIG. 10A, on a plane 1701 along which a curved surface 1700 is cut, part of a curve 1702 forming the curved surface 1700, is approximate to an arc of a circle, and the radius of the circle is referred to as a radius 1703 of curvature and the center of the circle is referred to as a center 1704 of curvature. FIG. 10B is a top view of the curved surface 1700. FIG. 10C is a cross-sectional view of the curved surface 1700 taken along the plane 1701. When a curved surface is cut along a plane, the radius of curvature of a curve in a cross section differs depending on the angle between the curved surface and the plane or on the cut position, and the smallest radius of curvature is define as the radius of curvature of a surface in this specification and the like.

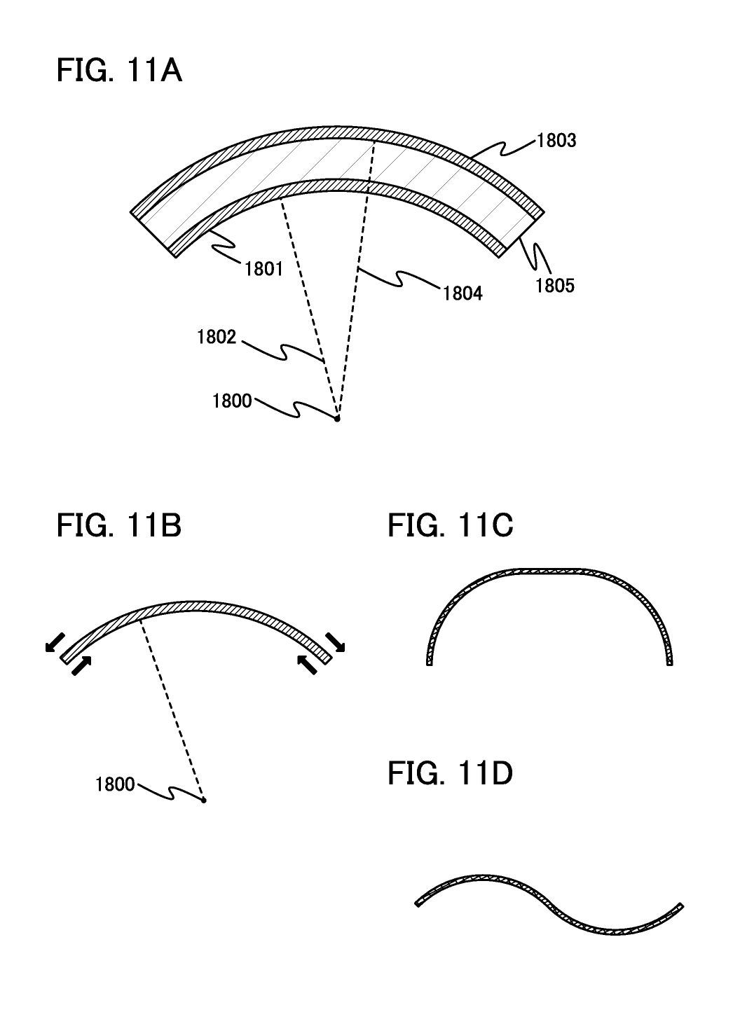

In the case of bending a power storage device in which a component 1805 including electrodes and an electrolytic solution is sandwiched between two films as exterior bodies, a radius 1802 of curvature of a film 1801 close to a center 1800 of curvature of the power storage device is smaller than a radius 1804 of curvature of a film 1803 far from the center 1800 of curvature (FIG. 11A). When the power storage device is curved and has an arc-shaped cross section, compressive stress is applied to a surface of the film on the side closer to the center 1800 of curvature and tensile stress is applied to a surface of the film on the side farther from the center 1800 of curvature (FIG. 11B). However, by forming a pattern including projections or depressions on surfaces of the exterior bodies, the influence of a strain can be reduced to be acceptable even when compressive stress and tensile stress are applied. For this reason, the power storage device can change its form such that the exterior body on the side closer to the center of curvature has a curvature radius greater than or equal to 10 mm, preferably greater than or equal to 30 mm

Note that the cross-sectional shape of the power storage device is not limited to a simple arc shape, and the cross section can be partly arc-shaped; for example, a shape illustrated in FIG. 11C, a wavy shape illustrated in FIG. 11D, or an S shape can be used. When the curved surface of the power storage device has a shape with a plurality of centers of curvature, the power storage device can change its form such that a curved surface with the smallest radius of curvature among radii of curvature with respect to the plurality of centers of curvature, which is a surface of the exterior body on the side closer to the center of curvature, has a curvature radius greater than or equal to 10 mm, preferably greater than or equal to 30 mm.

Note that in this embodiment, the coin-type power storage device, the cylindrical power storage device, and the thin power storage device are given as examples of the power storage device; however, any of power storage devices with a variety of shapes, such as a sealed power storage device and a square-type power storage device, can be used. Furthermore, a structure in which a plurality of positive electrodes, a plurality of negative electrodes, and a plurality of separators are stacked or wound may be employed.

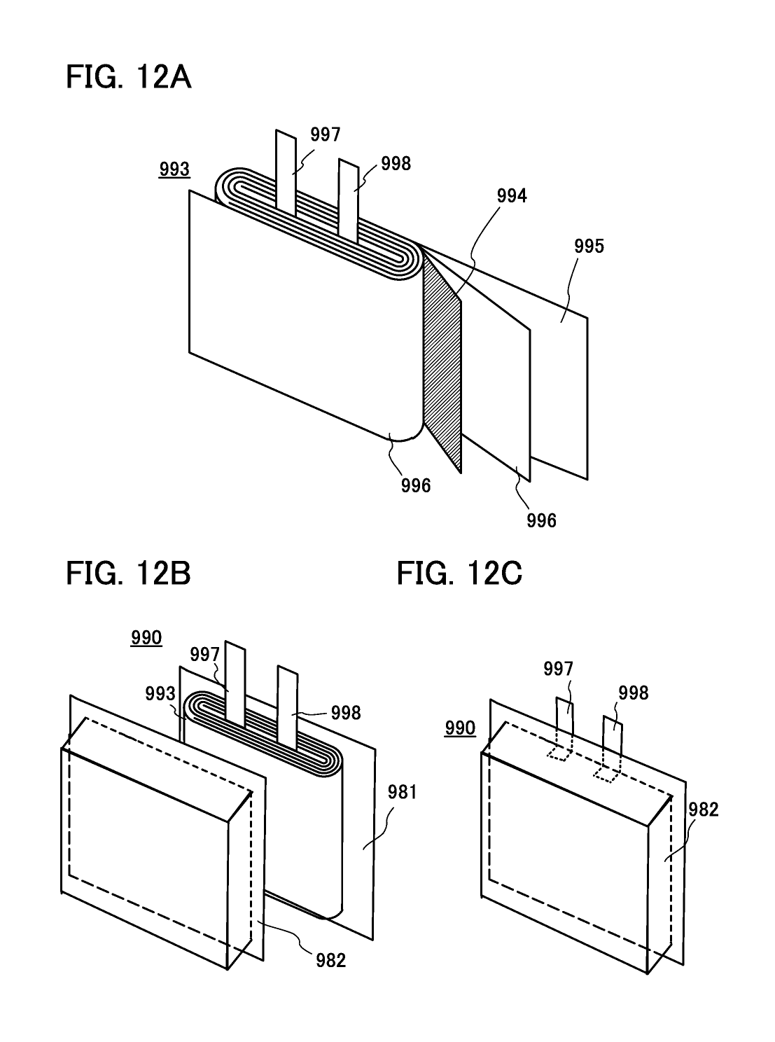

The thin power storage device is not limited to that illustrated in FIG. 6, and other examples of thin power storage devices are illustrated in FIGS. 12A to 12C. A wound body 993 illustrated in FIG. 12A includes a negative electrode 994, a positive electrode 995, and a separator 996.

The wound body 993 is obtained by winding a sheet of a stack in which the negative electrode 994 overlaps with the positive electrode 995 with the separator 996 therebetween. The wound body 993 is covered with a rectangular sealed container or the like; thus, a rectangular power storage device is fabricated.

Note that the number of stacks each including the negative electrode 994, the positive electrode 995, and the separator 996 is determined as appropriate depending on capacity and element volume which are required. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

In a power storage device 990 illustrated in FIGS. 12B and 12C, the wound body 993 is packed in a space formed by bonding a film 981 and a film 982 having a depressed portion that serve as exterior bodies by thermocompression bonding or the like. The wound body 993 includes the lead electrode 997 and the lead electrode 998, and is soaked in an electrolytic solution inside a space surrounded by the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible power storage device can be fabricated.

Although FIGS. 12B and 12C illustrate an example where a space is formed by two films, the wound body 993 may be placed in a space formed by bending one film.

Furthermore, not only a thin power storage device but also an exterior body and a sealed container may have flexibility. In that case, a resin material or the like is used for the exterior body and the sealed container. Note that in the case where a resin material is used for the exterior body and the sealed container, a conductive material is used for a portion connected to the outside.

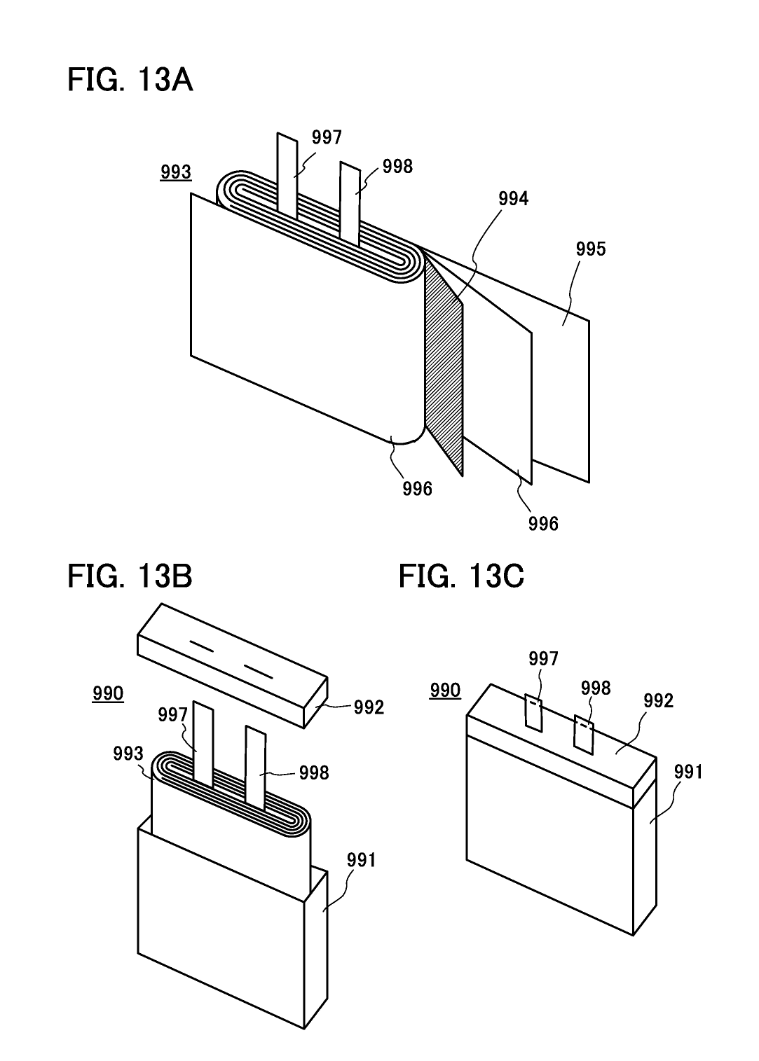

For example, FIGS. 13B and 13C illustrate an example of a power storage device in which the form of an exterior body is different from that of the exterior body in FIGS. 12B and 12C. The wound body 993 illustrated in FIG. 13A is the same as that illustrated in FIG. 12A, and a detailed description thereof is omitted.

In the power storage device 990 illustrated in FIGS. 13B and 13C, the wound body 993 is packed in an exterior body 991. The wound body 993 includes the lead electrode 997 and the lead electrode 998, and is soaked in an electrolytic solution inside a space surrounded by the exterior body 991 and an exterior body 992. For example, a metal material such as aluminum or a resin material can be used for the exterior bodies 991 and 992. With the use of a resin material for the exterior bodies 991 and 992, the exterior bodies 991 and 992 can be changed in their forms when external force is applied; thus, a flexible rectangular power storage device can be fabricated.

Structural examples of power storage systems will be described with reference to FIGS. 14A and 14B, FIGS. 15A-1 to 15B-2, and FIGS. 16A and 16B.

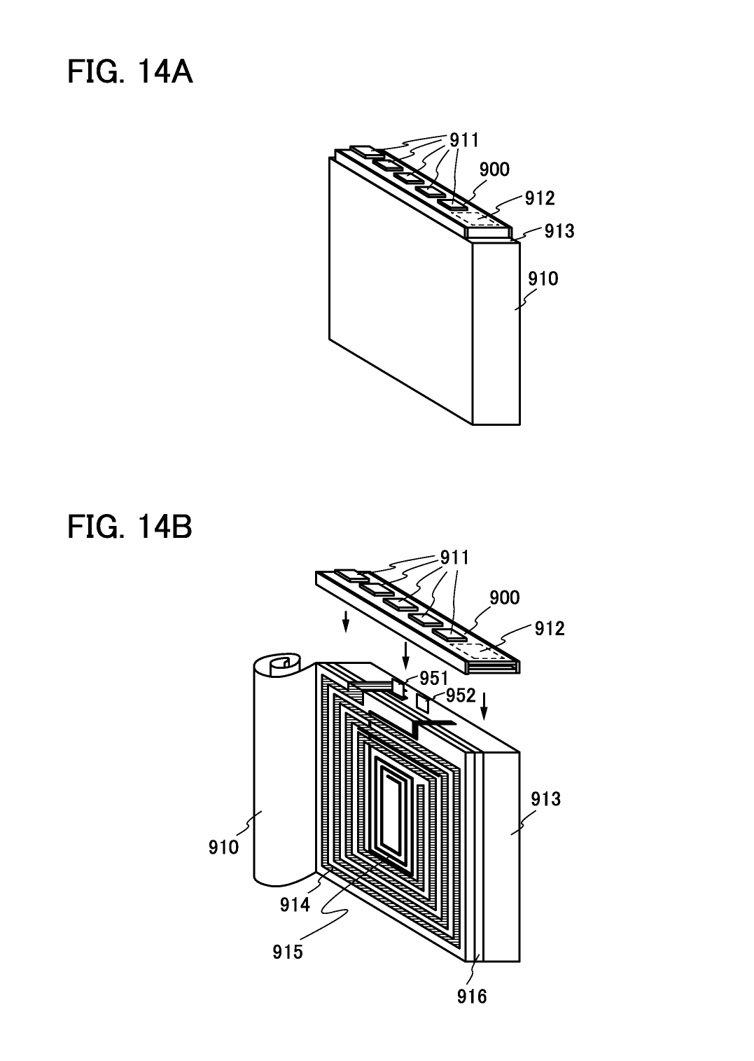

FIGS. 14A and 14B are external views of a power storage system. The power storage system includes a circuit board 900 and a power storage device 913. A label 910 is attached to the power storage device 913. As shown in FIG. 14B, the power storage system further includes a terminal 951 and a terminal 952, and includes an antenna 914 and an antenna 915 between the power storage device 913 and the label 910.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may be provided.

The circuit 912 may be provided on the rear surface of the circuit board 900. The shape of each of the antennas 914 and 915 is not limited to a coil shape and may be a linear shape or a plate shape. Further, a planar antenna, an aperture antenna, a traveling-wave antenna, an EH antenna, a magnetic-field antenna, or a dielectric antenna may be used. Alternatively, the antenna 914 or the antenna 915 may be a flat-plate conductor. The flat-plate conductor can serve as one of conductors for electric field coupling. That is, the antenna 914 or the antenna 915 can serve as one of two conductors of a capacitor. Thus, electric power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage system includes a layer 916 between the power storage device 913 and the antennas 914 and 915. The layer 916 may have a function of blocking an electromagnetic field by the power storage device 913. As the layer 916, for example, a magnetic body can be used.

Note that the structure of the power storage system is not limited to that shown in FIGS. 14A and 14B.

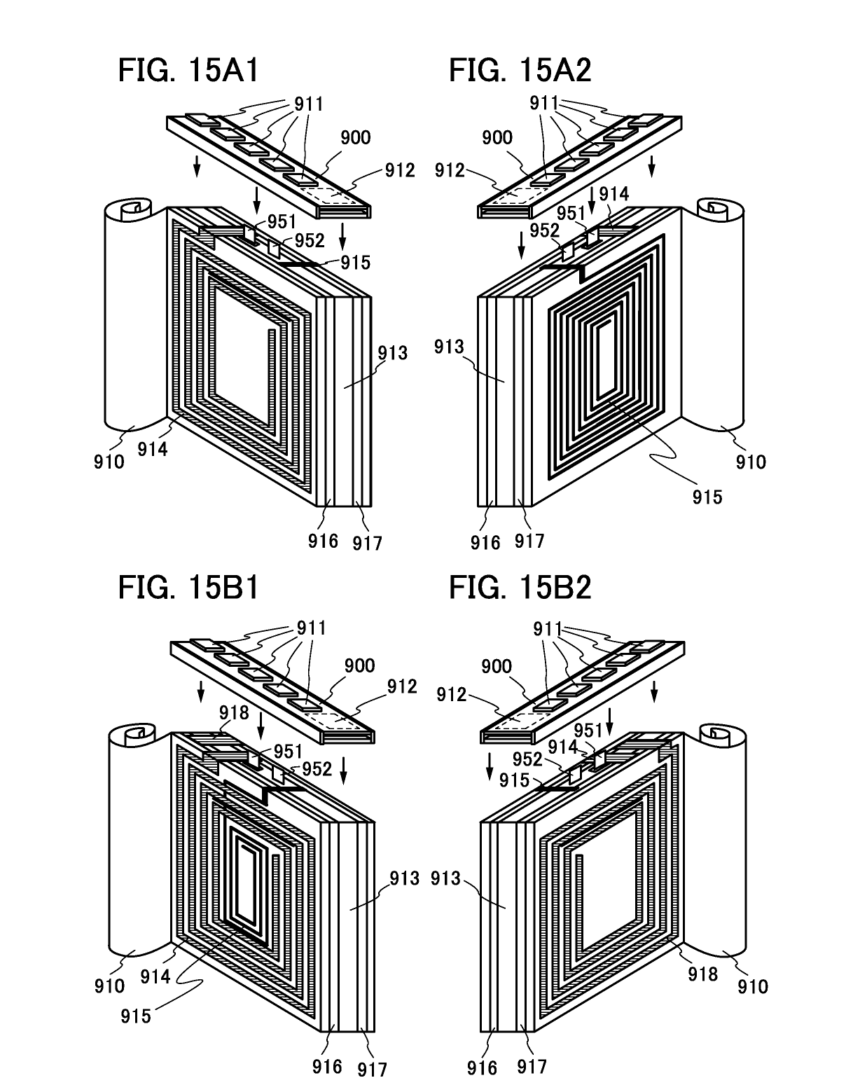

For example, as shown in FIGS. 15A1 and 15A2, two opposite surfaces of the power storage device 913 in FIGS. 14A and 14B may be provided with respective antennas. FIG. 15A1 is an external view showing one side of the opposite surfaces, and FIG. 15A2 is an external view showing the other side of the opposite surfaces. For portions similar to those in FIGS. 14A and 14B, a description of the power storage system illustrated in FIGS. 14A and 14B can be referred to as appropriate.

As illustrated in FIG. 15A1, the antenna 914 is provided on one of the opposite surfaces of the power storage device 913 with the layer 916 interposed therebetween, and as illustrated in FIG. 15A2, the antenna 915 is provided on the other of the opposite surfaces of the power storage device 913 with a layer 917 interposed therebetween. The layer 917 may have a function of preventing an adverse effect on an electromagnetic field by the power storage device 913. As the layer 917, for example, a magnetic body can be used.

With the above structure, both of the antennas 914 and 915 can be increased in size.

Alternatively, as illustrated in FIGS. 15B1 and 15B2, two opposite surfaces of the power storage device 913 in FIGS. 14A and 14B may be provided with different types of antennas. FIG. 15B1 is an external view showing one side of the opposite surfaces, and FIG. 15B2 is an external view showing the other side of the opposite surfaces. For portions similar to those in FIGS. 14A and 14B, a description of the power storage system illustrated in FIGS. 14A and 14B can be referred to as appropriate.

As illustrated in FIG. 15B1, the antenna 914 is provided on one of the opposite surfaces of the power storage device 913 with the layer 916 interposed therebetween, and as illustrated in FIG. 15B2, an antenna 918 is provided on the other of the opposite surfaces of the power storage device 913 with the layer 917 interposed therebetween. The antenna 918 has a function of communicating data with an external device, for example. An antenna with a shape that can be applied to the antennas 914 and 915, for example, can be used as the antenna 918. As a system for communication using the antenna 918 between the power storage system and another device, a response method that can be used between the power storage system and another device, such as NFC, can be employed.

Alternatively, as illustrated in FIG. 16A, the power storage device 913 in FIGS. 14A and 14B may be provided with a display device 920. The display device 920 is electrically connected to the terminal 911 via a terminal 919. It is possible that the label 910 is not provided in a portion where the display device 920 is provided. For portions similar to those in FIGS. 14A and 14B, a description of the power storage system illustrated in FIGS. 14A and 14B can be referred to as appropriate.

The display device 920 can display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 16B, the power storage device 913 illustrated in FIGS. 14A and 14B may be provided with a sensor 921. The sensor 921 is electrically connected to the terminal 911 via a terminal 922. Note that the sensor 921 may be provided between the power storage device 913 and the label 910. For portions similar to those in FIGS. 14A and 14B, a description of the power storage system illustrated in FIGS. 14A and 14B can be referred to as appropriate.

As the sensor 921, a sensor that has a function of measuring, for example, force, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays can be used. With the sensor 921, for example, data on an environment (e.g., temperature) where the power storage system is placed can be determined and stored in a memory inside the circuit 912.

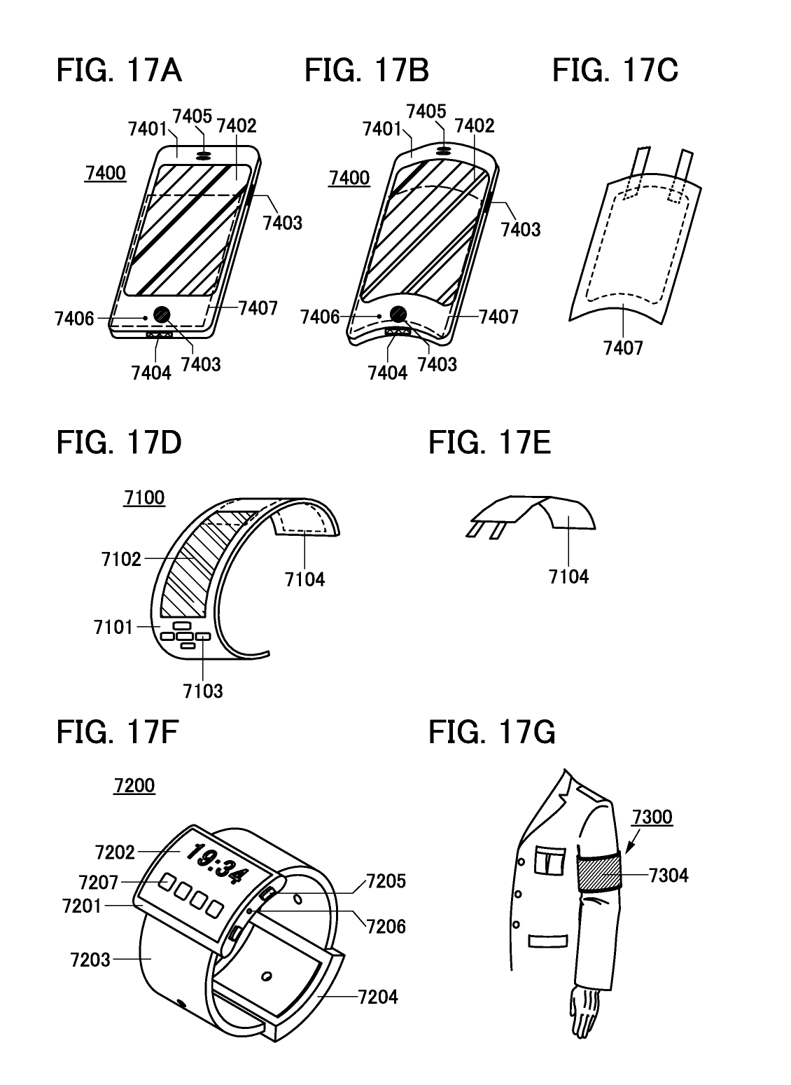

FIGS. 17A to 17G illustrate examples of electronic devices including the flexible power storage devices described in FIG. 6, FIGS. 12A to 12C, and FIGS. 13A to 13C. Examples of electronic devices each including a flexible power storage device include television devices (also referred to as televisions or television receivers), monitors of computers or the like, cameras such as digital cameras and digital video cameras, digital photo frames, mobile phones (also referred to as mobile phones or mobile phone devices), portable game machines, portable information terminals, audio reproducing devices, and large game machines such as pachinko machines.

Note that in this embodiment, the coin-type power storage device, the thin power storage device, and the cylindrical power storage device are given as examples of the power storage device; however, any of power storage devices with a variety of shapes, such as a sealed power storage device and a square-type power storage device, can be used. Furthermore, a structure in which a plurality of positive electrodes, a plurality of negative electrodes, and a plurality of separators are stacked or wound may be employed.

As the positive electrodes and the negative electrodes of the power storage device 300, the power storage device 500, and the power storage device 600, which are described in this embodiment, electrodes formed by the method for fabricating an electrode for a power storage device of one embodiment of the present invention are used. Thus, the discharge capacity of the power storage devices 300, 500, and 600 can be increased.

This embodiment can be implemented in appropriate combination with any of the other embodiments.

### Embodiment 5

In this embodiment, examples of providing the flexible power storage device described in Embodiment 4 in an electronic device will be described with reference to FIGS. 17A to 17G.

FIG. 17A illustrates an example of a mobile phone. A mobile phone 7400 is provided with a display portion 7402 incorporated in a housing 7401, an operation button 7403, an external connection port 7404, a speaker 7405, a microphone 7406, and the like. Note that the mobile phone 7400 includes a power storage device 7407.

FIG. 17B illustrates the mobile phone 7400 that is bent. When the whole mobile phone 7400 is bent by the external force, the power storage device 7407 included in the mobile phone 7400 is also bent. FIG. 17C illustrates the bent power storage device 7407. The power storage device 7407 is a thin power storage device. The power storage device 7407 is fixed in a state of being bent. Note that the power storage device 7407 includes a lead electrode 7408 electrically connected to a current collector 7409. The current collector 7409 is, for example, copper foil, and partly alloyed with gallium; thus, adhesion between the current collector 7409 and an active material layer in contact with the current collector 7409 is improved and the power storage device 7407 can have high reliability even in a state of being bent.

FIG. 17D illustrates an example of a bangle display device. A portable display device 7100 includes a housing 7101, a display portion 7102, an operation button 7103, and a power storage device 7104. FIG. 17E illustrates the bent power storage device 7104. When the display device is worn on a user's arm while the power storage device 7104 is bent, the housing changes its form and the curvature of a part or the whole of the power storage device 7104 is changed. Note that the radius of curvature of a curve at a point refers to the radius of the circular arc that best approximates the curve at that point. The reciprocal of the radius of curvature is curvature. Specifically, a part or the whole of the housing or the main surface of the power storage device 7104 is changed in the range of radius of curvature from 40 mm to 150 mm. When the radius of curvature at the main surface of the power storage device 7104 is greater than or equal to 40 mm and less than or equal to 150 mm, the reliability can be kept high. Note that the power storage device 7104 includes a lead electrode 7105 that is electrically connected to a current collector 7106. The current collector 7106 is, for example, a copper foil, and partly alloyed with gallium; thus, adhesion between the current collector 7106 and an active material layer in contact with the current collector 7106 is improved and the power storage device 7104 can have high reliability even when the power storage device 7104 is bent and its curvature is changed many times.

FIG. 17F illustrates an example of a watch-type portable information terminal. A portable information terminal 7200 includes a housing 7201, a display portion 7202, a band 7203, a buckle 7204, an operation button 7205, an input output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as power on/off, on/off of wireless communication, setting and cancellation of a manner mode, and setting and cancellation of a power saving mode can be performed. For example, the functions of the operation button 7205 can be set freely by setting the operation system incorporated in the portable information terminal 7200.

The portable information terminal 7200 can employ near field communication that is a communication method based on an existing communication standard. In that case, for example, mutual communication between the portable information terminal 7200 and a headset capable of wireless communication can be performed, and thus hands-free calling is possible.

Moreover, the portable information terminal 7200 includes the input output terminal 7206, and data can be directly transmitted to and received from another information terminal via a connector. In addition, charging via the input output terminal 7206 is possible. Note that the charging operation may be performed by wireless power feeding without using the input output terminal 7206.

The display portion 7202 of the portable information terminal 7200 is provided with a power storage device including the electrode member of one embodiment of the present invention. For example, the power storage device 7104 illustrated in FIG. 17E that is in the state of being curved can be provided in the housing 7201. Alternatively, the power storage device 7104 illustrated in FIG. 17E can be provided in the band 7203 such that it can be curved.

FIG. 17G illustrates an example of an armband display device. A display device 7300 includes a display portion 7304 and the power storage device of one embodiment of the present invention. The display device 7300 can include a touch sensor in the display portion 7304 and can serve as a portable information terminal.

The display surface of the display portion 7304 is bent, and images can be displayed on the bent display surface. A display state of the display device 7300 can be changed by, for example, near field communication, which is a communication method based on an existing communication standard.

The display device 7300 includes an input output terminal, and data can be directly transmitted to and received from another information terminal via a connector. In addition, charging via the input output terminal is possible. Note that the charging operation may be performed by wireless power feeding without using the input output terminal.

This embodiment can be implemented in appropriate combination with any of the other embodiments.

### Embodiment 6

A power storage device including the electrode for a power storage device of one embodiment of the present invention can be used for power supplies of a variety of electrical devices driven by power.

Specific examples of electrical devices each utilizing a power storage device including the electrode for a power storage device of one embodiment of the present invention are as follows: display devices of televisions, monitors, and the like, lighting devices, desktop personal computers and laptop personal computers, word processors, image reproduction devices which reproduce still images and moving images stored in recording media such as digital versatile discs (DVDs), portable CD players, portable radios, tape recorders, headphone stereos, stereos, table clocks, wall clocks, cordless phone handsets, transceivers, mobile phones, car phones, portable game machines, calculators, portable information terminals, electronic notebooks, e-book readers, electronic translators, audio input devices, video cameras, digital still cameras, toys, electric shavers, high-frequency heating appliances such as microwave ovens, electric rice cookers, electric washing machines, electric vacuum cleaners, water heaters, electric fans, hair dryers, air-conditioning systems such as air conditioners, humidifiers, and dehumidifiers, dishwashers, dish dryers, clothes dryers, futon dryers, electric refrigerators, electric freezers, electric refrigerator-freezers, freezers for preserving DNA, flashlights, electrical tools such as a chain saw, smoke detectors, and medical equipment such as dialyzers. Further, industrial equipment such as guide lights, traffic lights, belt conveyors, elevators, escalators, industrial robots, power storage systems, and power storage devices for leveling the amount of power supply and smart grid can be given. In addition, moving objects driven by electric motors using electric power from the power storage devices are also included in the category of electrical devices. Examples of the moving objects are electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, motorized bicycles including motor-assisted bicycles, motorcycles, electric wheelchairs, golf carts, boats, ships, submarines, helicopters, aircrafts, rockets, artificial satellites, space probes, planetary probes, and spacecrafts.

In the electrical devices, the power storage device including the electrode for a power storage device of one embodiment of the present invention can be used as a main power supply for supplying enough electric power for almost the whole power consumption. Alternatively, in the electrical devices, the power storage device including the electrode for a power storage device of one embodiment of the present invention can be used as an uninterruptible power supply which can supply electric power to the electrical devices when the supply of electric power from the main power supply or a commercial power supply is stopped. Still alternatively, in the electrical devices, the power storage device including the electrode for a power storage device of one embodiment of the present invention can be used as an auxiliary power supply for supplying electric power to the electrical devices at the same time as the power supply from the main power supply or a commercial power supply.

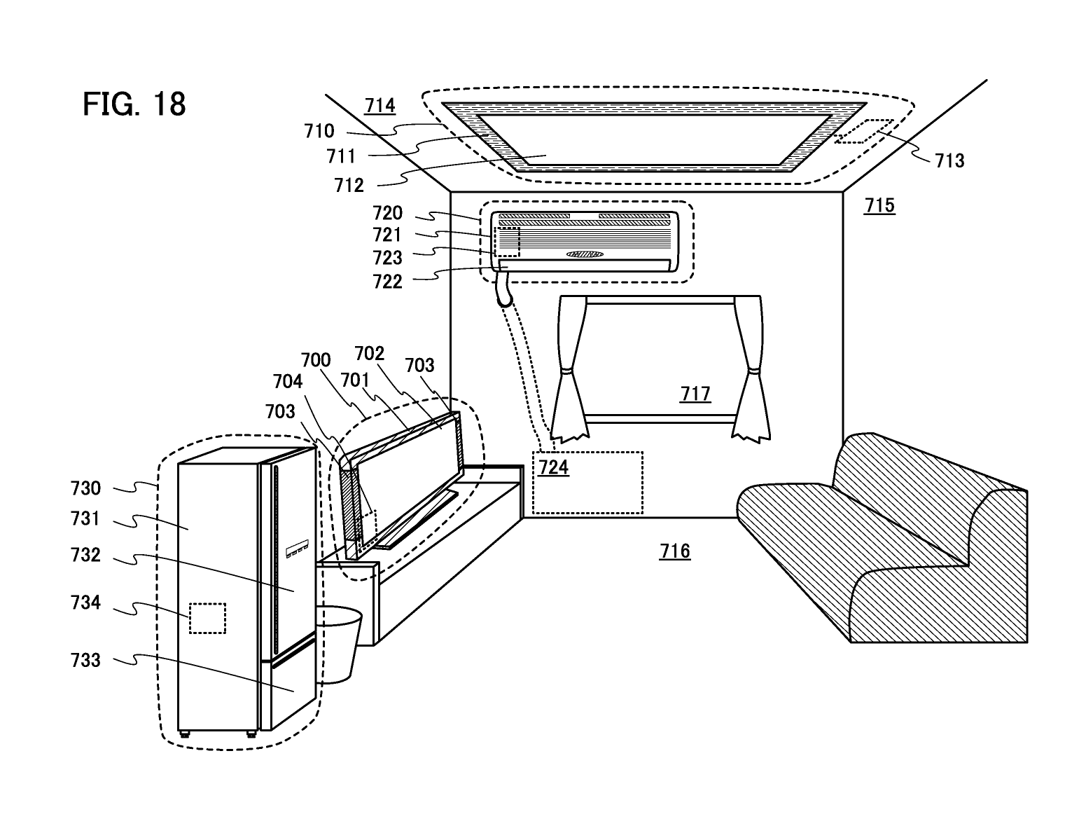

FIG. 18 illustrates specific structures of the electrical devices. In FIG. 18, a display device 700 is an example of an electrical device including a power storage device 704 including the electrode for a power storage device of one embodiment of the present invention. Specifically, the display device 700 corresponds to a display device for TV broadcast reception and includes a housing 701, a display portion 702, speaker portions 703, and the power storage device 704. The power storage device 704 including the electrode for a power storage device of one embodiment of the present invention is provided in the housing 701. The display device 700 can receive electric power from a commercial power supply. Alternatively, the display device 700 can use electric power stored in the power storage device 704 including the electrode for a power storage device of one embodiment of the present invention. Thus, the display device 700 can be operated with the use of the power storage device 704 including the electrode for a power storage device of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 702.

Note that the display device includes, in its category, all of information display devices for personal computers, advertisement displays, and the like besides TV broadcast reception.

In FIG. 18, an installation lighting device 710 is an example of an electrical device including a power storage device 713 including the electrode for a power storage device of one embodiment of the present invention. Specifically, the lighting device 710 includes a housing 711, a light source 712, and the power storage device 713. Although FIG. 18 illustrates the case where the power storage device 713 is provided in a ceiling 714 on which the housing 711 and the light source 712 are installed, the power storage device 713 may be provided in the housing 711. The lighting device 710 can receive electric power from a commercial power supply. Alternatively, the lighting device 710 can use electric power stored in the power storage device 713. Thus, the lighting device 710 can be operated with the use of power storage device 713 including the electrode for a power storage device of one embodiment of the present invention as an uninterruptible power supply even when electric power cannot be supplied from a commercial power supply due to power failure or the like.

Note that although the installation lighting device 710 provided in the ceiling 714 is illustrated in FIG. 18 as an example, the power storage device including the electrode for a power storage device of one embodiment of the present invention can be used in an installation lighting device provided in, for example, a wall 715, a floor 716, a window 717, or the like other than the ceiling 714. Alternatively, the power storage device including the electrode for a power storage device of one embodiment of the present invention can be used in a tabletop lighting device or the like.

As the light source 712, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 18, an air conditioner including an indoor unit 720 and an outdoor unit 724 is an example of an electrical device including a power storage device 723 including the electrode for a power storage device of one embodiment of the present invention. Specifically, the indoor unit 720 includes a housing 721, an air outlet 722, and the power storage device 723. Although FIG. 18 illustrates the case where the power storage device 723 is provided in the indoor unit 720, the power storage device 723 may be provided in the outdoor unit 724. Alternatively, the power storage devices 723 may be provided in both the indoor unit 720 and the outdoor unit 724. The air conditioner can receive electric power from a commercial power supply. Alternatively, the air conditioner can use electric power stored in the power storage device 723. Particularly in the case where the power storage devices 723 are provided in both the indoor unit 720 and the outdoor unit 724, the air conditioner can be operated with the use of the power storage device 723 including the electrode for a power storage device of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 18 as an example, the power storage device including the electrode for a power storage device of one embodiment of the present invention can be used in an air conditioner in which the functions of an indoor unit and an outdoor unit are integrated in one housing.

In FIG. 18, an electric refrigerator-freezer 730 is an example of an electrical device including a power storage device 734 including the electrode for a power storage device of one embodiment of the present invention. Specifically, the electric refrigerator-freezer 730 includes a housing 731, a door for a refrigerator 732, a door for a freezer 733, and the power storage device 734. The power storage device 734 is provided in the housing 731 in FIG. 18. The electric refrigerator-freezer 730 can receive electric power from a commercial power supply. Alternatively, the electric refrigerator-freezer 730 can use electric power stored in the power storage device 734. Thus, the electric refrigerator-freezer 730 can be operated with the use of the power storage device 734 including the electrode for a power storage device of one embodiment of the present invention as an uninterruptible power supply even when electric power cannot be supplied from a commercial power supply due to power failure or the like.

Note that among the electrical devices described above, a high-frequency heating apparatus such as a microwave oven and an electrical device such as an electric rice cooker require high power in a short time. The tripping of a breaker of a commercial power supply in use of an electrical device can be prevented by using the power storage device including the electrode for a power storage device of one embodiment of the present invention as an auxiliary power supply for supplying electric power which cannot be supplied enough by a commercial power supply.

In addition, in a time period when electrical devices are not used, particularly when the proportion of the amount of electric power which is actually used to the total amount of electric power which can be supplied from a commercial power supply source (such a proportion referred to as a usage rate of electric power) is low, electric power can be stored in the power storage device, whereby the usage rate of electric power can be reduced in a time period when the electrical devices are used. For example, in the case of the electric refrigerator-freezer 730, electric power can be stored in the power storage device 734 in night time when the temperature is low and the door for a refrigerator 732 and the door for a freezer 733 are not often opened or closed. On the other hand, in daytime when the temperature is high and the door for a refrigerator 732 and the door for a freezer 733 are frequently opened and closed, the power storage device 734 is used as an auxiliary power supply; thus, the usage rate of electric power in daytime can be reduced.

This embodiment can be implemented in combination with any of the other embodiments as appropriate.

### Embodiment 7

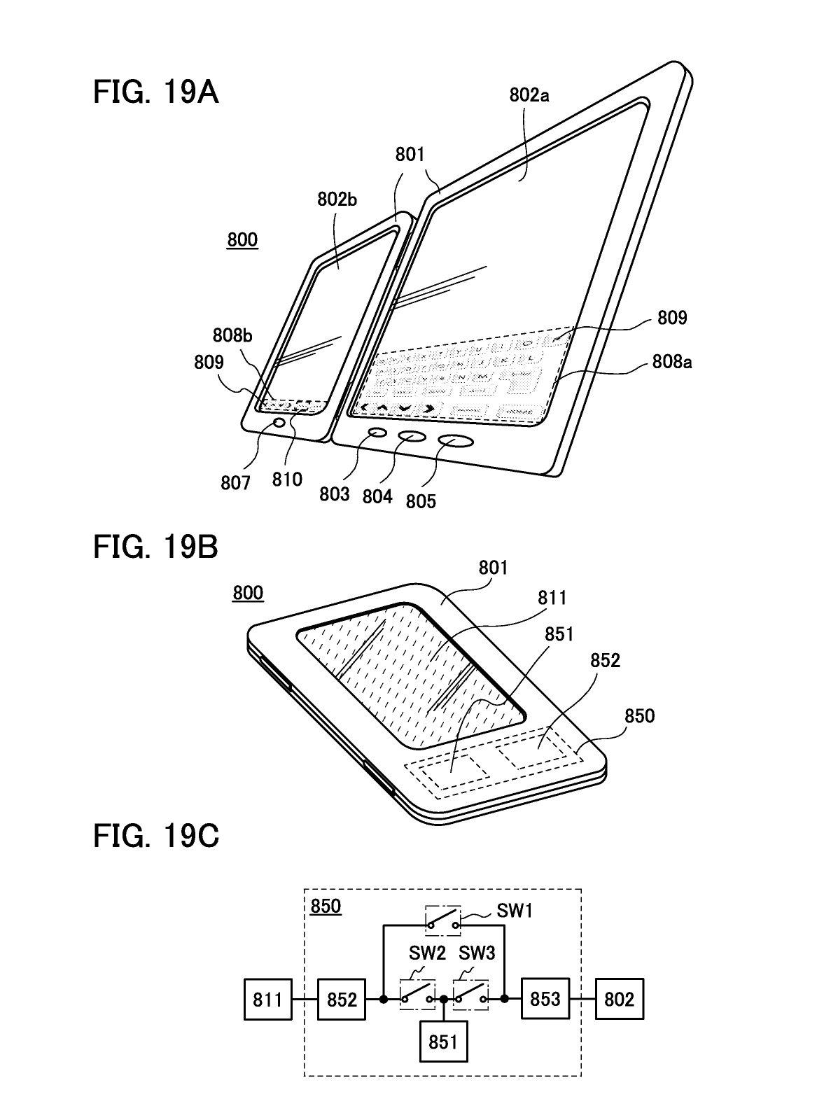

Next, a portable information terminal which is an example of electrical devices will be described with reference to FIGS. 19A to 19C.

FIGS. 19A and 19B illustrate a tablet terminal 800 which can be folded. FIG. 19A illustrates the tablet terminal 800 in the state of being unfolded. The tablet terminal includes a housing 801, a display portion 802a, a display portion 802b, a display-mode switching button 803, a power button 804, a power-saving-mode switching button 805, and an operation button 807.

A touch panel area 808a can be provided in part of the display portion 802a, in which area, data can be input by touching displayed operation keys 809. Note that half of the display portion 802a has only a display function and the other half has a touch panel function. However, the structure of the display portion 802a is not limited to this, and all the area of the display portion 802a may have a touch panel function. For example, a keyboard can be displayed on the whole display portion 802a to be used as a touch panel, and the display portion 802b can be used as a display screen.

A touch panel area 808b can be provided in part of the display portion 802b like in the display portion 802a. When a keyboard display switching button 810 displayed on the touch panel is touched with a finger, a stylus, or the like, a keyboard can be displayed on the display portion 802b.

The touch panel area 808a and the touch panel area 808b can be controlled by touch input at the same time.

The display-mode switching button 803 allows switching between a landscape mode and a portrait mode, color display and black-and-white display, and the like. The power-saving-mode switching button 805 allows optimizing the display luminance in accordance with the amount of external light in use which is detected by an optical sensor incorporated in the tablet terminal. In addition to the optical sensor, other detecting devices such as sensors for determining inclination, such as a gyroscope or an acceleration sensor, may be incorporated in the tablet terminal.

Although the display area of the display portion 802a is the same as that of the display portion 802b in FIG. 19A, one embodiment of the present invention is not particularly limited thereto. The display area of the display portion 802a may be different from that of the display portion 802b, and further, the display quality of the display portion 802a may be different from that of the display portion 802b. For example, one of the display portions 802a and 802b may display higher definition images than the other.

FIG. 19B illustrates the tablet terminal 800 in the state of being closed. The tablet terminal 800 includes the housing 801, a solar cell 811, a charge/discharge control circuit 850, a battery 851, and a DC-DC converter 852. FIG. 19B illustrates an example where the charge/discharge control circuit 850 includes the battery 851 and the DC-DC converter 852. The power storage device including the electrode for a power storage device of one embodiment of the present invention, which is described in the above embodiment, is used as the battery 851.

Since the tablet terminal can be folded, the housing 801 can be closed when the tablet terminal is not in use. Thus, the display portions 802a and 802b can be protected, which permits the tablet terminal 800 to have high durability and improved reliability for long-term use.

The tablet terminal illustrated in FIGS. 19A and 19B can also have a function of displaying various kinds of data (e.g., a still image, a moving image, and a text image), a function of displaying a calendar, a date, the time, or the like on the display portion, a touch-input function of operating or editing data displayed on the display portion by touch input, a function of controlling processing by various kinds of software (programs), and the like.

The solar cell 811, which is attached on a surface of the tablet terminal, can supply electric power to a touch panel, a display portion, an image signal processor, and the like. Note that the solar cell 811 can be provided on one or both surfaces of the housing 801 and thus the battery 851 can be charged efficiently.

The structure and operation of the charge/discharge control circuit 850 illustrated in FIG. 19B will be described with reference to a block diagram of FIG. 19C. FIG. 19C illustrates the solar cell 811, the battery 851, the DC-DC converter 852, a converter 853, switches SW1 to SW3, and the display portion 802. The battery 851, the DC-DC converter 852, the converter 853, and the switches SW1 to SW3 correspond to the charge and discharge control circuit 850 in FIG. 19B.

First, an example of operation in the case where electric power is generated by the solar cell 811 using external light will be described. The voltage of electric power generated by the solar cell is raised or lowered by the DC-DC converter 852 so that the electric power has a voltage for charging the battery 851. When the display portion 802 is operated with the electric power from the solar cell 811, the switch SW1 is turned on and the voltage of the electric power is raised or lowered by the converter 853 to a voltage needed for operating the display portion 802. In addition, when display on the display portion 802 is not performed, the switch SW1 is turned off and the switch SW2 is turned on so that the battery 851 may be charged.

Although the solar cell 811 is described as an example of a power generation means, there is no particular limitation on the power generation means, and the battery 851 may be charged with any of the other means such as a piezoelectric element or a thermoelectric conversion element (Peltier element). For example, the battery 851 may be charged with a non-contact power transmission module capable of performing charging by transmitting and receiving electric power wirelessly (without contact), or any of the other charge means used in combination.

It is needless to say that one embodiment of the present invention is not limited to the electrical device illustrated in FIGS. 19A to 19C as long as the electrical device is equipped with the power storage device including the electrode for a power storage device of one embodiment of the present invention, which is described in the above embodiment.

### Embodiment 8

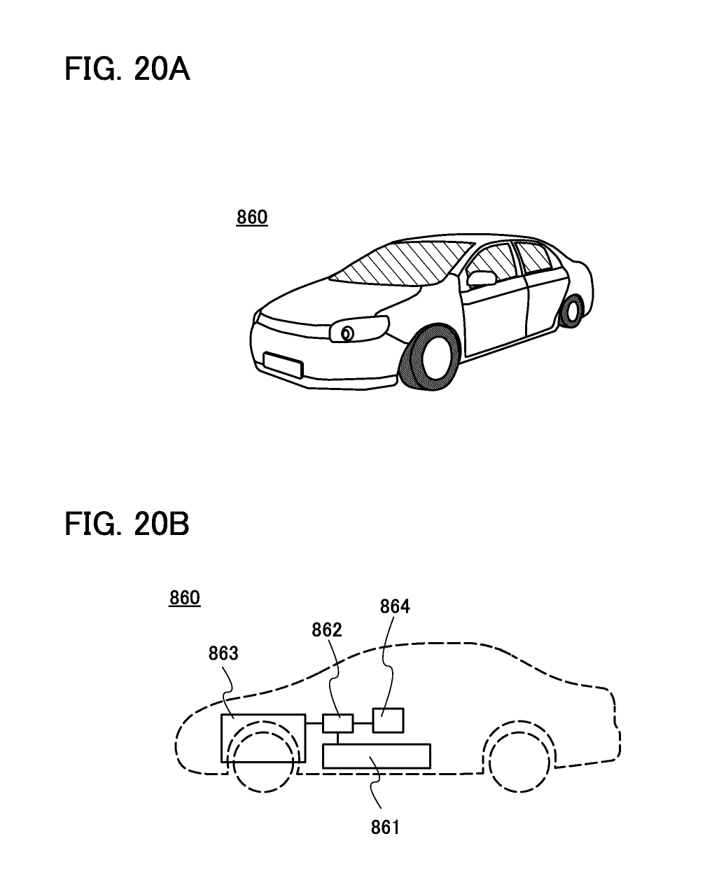

Further, an example of the moving object which is an example of the electrical devices will be described with reference to FIGS. 20A and 20B.

The power storage device described in the above embodiment can be used as a control battery. The control battery can be externally charged by electric power supply using a plug-in technique or contactless power feeding. Note that in the case where the moving object is an electric railway vehicle, the electric railway vehicle can be charged by electric power supply from an overhead cable or a conductor rail.

FIGS. 20A and 20B illustrate an example of an electric vehicle. An electric vehicle 860 is equipped with a battery 861. The output of the electric power of the battery 861 is adjusted by a control circuit 862 and the electric power is supplied to a driving device 863. The control circuit 862 is controlled by a processing unit 864 including a ROM, a RAM, a CPU, or the like which is not illustrated.

The driving device 863 includes a DC motor or an AC motor either alone or in combination with an internal-combustion engine. The processing unit 864 outputs a control signal to the control circuit 862 based on input data such as data on operation (e.g., acceleration, deceleration, or stop) of a driver or data during driving (e.g., data on an upgrade or a downgrade, or data on a load on a driving wheel) of the electric vehicle 860. The control circuit 862 adjusts the electric energy supplied from the battery 861 in accordance with the control signal of the processing unit 864 to control the output of the driving device 863. In the case where the AC motor is mounted, although not illustrated, an inverter which converts direct current into alternate current is also incorporated.

The battery 861 can be charged by external electric power supply using a plug-in technique. For example, the battery 861 is charged through a power plug from a commercial power supply. The battery 861 can be charged by converting the supplied power into DC constant voltage having a predetermined voltage level through a converter such as an AC-DC converter. The use of the power storage device including the electrode for a power storage device of one embodiment of the present invention as the battery 861 can be conducive to an increase in battery capacity, leading to an improvement in convenience. When the battery 861 itself can be more compact and more lightweight as a result of improved characteristics of the battery 861, the vehicle can be lightweight, leading to an increase in fuel efficiency.

Note that it is needless to say that one embodiment of the present invention is not limited to the electrical device described above as long as the power storage device of one embodiment of the present invention is included.

This embodiment can be implemented in combination with any of the other embodiments as appropriate.

### Example 1

### Synthesis Method of Graphene Oxide

A dispersion liquid containing graphene oxide (hereinafter referred to as a graphene oxide dispersion liquid) was formed by the following method. First, 4 g of graphite (BF-40AK manufactured by Chuetsu Graphite Works Co., Ltd.) and 138 mL of concentrated sulfuric acid were mixed to form a mixed solution. Then, 15 g of potassium permanganate was added to the mixed solution while they were stirred in an ice bath. The ice bath was removed and stirring was performed in a water bath at 25° C. for 4.5 hours, so that Mixed Solution A containing graphite oxide was formed.

Next, 276 mL of pure water was added to Mixed Solution A containing graphite oxide while they were stirred in an ice bath. After the resulting mixed solution was stirred in an oil bath at approximately 95° C. for 15 minutes so that reaction was caused, 54 mL of hydrogen peroxide solution (with a concentration of 30%) was added to the mixed solution while they were stirred, in order to deactivate unreacted potassium permanganate. Consequently, Mixed Solution B was formed. Mixed Solution B was subjected to centrifugation to collect a precipitate.

Centrifugation of Mixed Solution C formed by adding 500 mL of pure water per approximately 5 g of the graphene oxide and collection of a precipitate were performed more than once, and the graphene oxide was washed.

Pure water was added to the graphene oxide again to form a graphene oxide dispersion liquid.

### (Forming Methods of Samples)

A substance obtained by drying the graphene oxide dispersion liquid formed by the above-described method is referred to as Substance A. Substance A includes graphene oxide.

L-ascorbic acid was added as a reducing agent to Substance A to prepare a graphene oxide dispersion aqueous solution containing approximately 0.27 g/L of graphene oxide and 77 mmol/L L-ascorbic acid. The graphene oxide dispersion aqueous solution was reacted in a hot-water bath at 80° C. for 8 hours. The reacted graphene oxide aggregated to form a lump, and the liquid was clear. The lump was washed with pure water, centrifugation or filtration was performed, and a precipitate was dried at room temperature in vacuum to obtain Substance B.

Here, L-ascorbic acid was used as the reducing agent of the graphene oxide. The redox reaction of the L-ascorbic acid can be expressed by Chemical Formula (A-1) or the like.

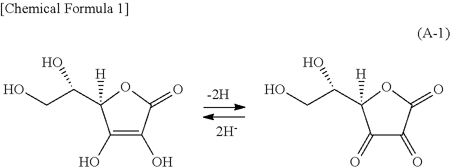 [SMILES: O=C1O[C@H]([C@@H](O)CO)C(O)=C1O ; O=C1O[C@H]([C@@H](O)CO)C(=O)C1=O]

Substance B was heated at 135° C. in vacuum for 1 hour and further heated at 170° C. for 1 hour. Subsequently, Substance B was heated at 300° C. for 10 hours, so that Substance C was formed. Substance C was obtained by performing chemical reduction and thermal reduction on a graphene oxide-including substance in this order. Substance C is referred to as Sample 1.

An example of forming a sample by another method will be described below. Graphene oxide was synthesized by a Modified Hummers method, dried, and pulverized. Then, heating was performed at 300° C. in vacuum for 10 hours as in the above-described method to obtain Substance D. Substance D was obtained by performing thermal reduction on a graphene oxide-including substance. Substance D is referred to as Sample 2 (a comparative example: a sample obtained by thermal reduction).

Substance B (this substance was subjected to thermal reduction later to form Sample 1) was obtained by performing chemical reduction on a graphene oxide-including substance. Substance B is referred to as Sample 3 (a comparative example: a sample obtained by chemical reduction). Substance A (this substance was subjected to chemical reduction and thermal reduction later to form Sample 1) included graphene oxide. Substance A is referred to as Reference Sample 1 (a reference example: a sample before reduction).

### (XPS Analysis)

Measurement of the compositions and the proportions of the carbon binding states based on the chemical shift amount of a 1 s orbital of carbon of Samples 1 to 3 and Reference Sample 1 prepared in the above manner was carried out by X-ray Photoelectron Spectroscopy (XPS). For XPS analysis, QuanteraSXM manufactured by ULVAC-PHI, INCORPORATED having a monochromatic Al X-ray source (1486.6 eV) was used as an X-ray source. Table 1 and Table 2 show analysis results.

TABLE 1

| Sample | C | O | S | Others | C/O |
|---|---|---|---|---|---|
| Reference Sample 1 | 64.1 | 34.0 | 1.3 | 0.6 | 1.89 |
| Sample 1 | 93.2 | 6.8 | — | — | 13.71 |
| Sample 2 | 87.1 | 12.9 | — | — | 6.75 |
| Sample 3 | 88.5 | 11.5 | — | — | 7.70 |

Unit: atomic %

TABLE 2

| Sample | C═C | C—C, C—H | C—O | C═O | O═C—O |
|---|---|---|---|---|---|
| Reference Sample 1 | — | 37.0 | 51.4 | 8.3 | 3.3 |
| Sample 1 | 78.6 | 12.2 | 5.9 | 1.6 | 1.7 |
| Sample 2 | 47.0 | 32.4 | 11.9 | 4.3 | 4.3 |
| Sample 3 | 75.2 | 10.8 | 8.3 | 3.1 | 2.6 |

Unit: %

Table 1 shows XPS analysis results of the compositions of the samples. The proportions (at. %) of carbon (C), oxygen (O), sulfur (S), and the other elements of the samples are shown. In the rightmost columns, the atomic ratios of carbon atoms to oxygen atoms (C/O) are shown. Sample 1 has a high C/O of 13.71 compared with Reference Sample 1 not subjected to reduction treatment, which suggests the reduction reaction of Sample 1.

Also in the atomic proportions of the carbon bonding states based on the chemical shift amount of a 1 s orbital of carbon in Table 2, a high proportion of sp² C═C bonds are observed. In addition, sulfur (S) in Samples 1 to 3 was not able to be detected, which implies that the sulfur was released from the graphene oxide.

Comparison of Sample 3 formed by chemical reduction with Sample 1 shows that the samples have similar compositions as shown in Table 1 and similar atomic proportions of carbon bonding states based on the chemical shift amount of a 1 s orbital of carbon as shown in Table 2. This suggests that the forming method of the invention disclosed in this specification can further promote reduction.

### (Measurement of Resistivities)

Pellets were formed using Samples 1, 2, and 3 in the form of powder obtained in the aforementioned manner, and the resistivities of the pellets were measured by a four-point van der Pauw method. For the measurement of the resistivities, ResiTest8300 (manufactured by TOYO Corporation) was used.

The pellets were formed using powdery Samples 1, 2, and 3 in such a manner that a pellet dice with a radius of 5 mm was filled with each sample and pressurization was performed by a hydraulic pump for 10 minutes and stopped, and after that, pressurization was performed again for 10 minutes. The pressure applied to powder per unit area was approximately 7.5 Mgf/cm². The obtained pellets are referred to as Pellet 1, Pellet 2, and Pellet 3.

Table 3 shows the measurement results of the resistivities.

TABLE 3

| Pellet | Resistivity [Ω · cm] |
|---|---|
| Pellet 1 | 1.02E−02 |
| Pellet 2 | 6.43E−01 |
| Pellet 3 | 2.80E−02 |

Pellet 3 of graphene oxide subjected to only chemical reduction has lower resistivity than Pellet 2 of graphene oxide subjected to only thermal reduction. It is known that the conductivity of graphene has a strong correlation to the proportion of sp² C═C bonds in the graphene; the higher the proportion of sp² C═C bonds is, the higher the conductivity is. The XPS analysis results show that the proportion of sp² C═C bonds in the atomic proportions of a C 1 s bonding state of Sample 3 is extremely higher than that of Sample 2. This corresponds to the fact that higher conductivity can be achieved in the case of performing chemical reduction than in the case of performing thermal reduction. Comparison results of the resistivities and the XPS analysis results between Pellets 3 and 1 have a similar tendency, which demonstrates that higher conductivity can be achieved by performing chemical reduction and thermal reduction in this order.

As described above, graphene formed by the method for forming graphene of one embodiment of the present invention in the form of powder (pellet) has a resistivity of 3.0×10⁻² Ω·cm or less, preferably 2.0×10⁻² Ω·cm or less, more preferably 1.5×10⁻² Ω·cm or less.

### Example 2

In this example, samples formed by methods different from those in Example 1 will be described.

### (Forming Methods of Samples)

An aqueous solution containing NMP at 90 vol % is referred to as Mixed Solvent 1.

L-ascorbic acid was added as a reducing agent to Substance A formed in Example 1 to prepare a graphene oxide dispersion liquid containing approximately 0.27 g/L of graphene oxide and 77 mmol/L L-ascorbic acid. The graphene oxide dispersion liquid was reacted in a hot-water bath at 60° C. for 1 hour. The reacted graphene oxide aggregated to form a lump, and the liquid was yellow clear. The lump was washed with pure water, centrifugation or filtration was performed, and a precipitate was dried at room temperature in vacuum to obtain Substance E.

Substance E was put into a vacuum furnace and pressure in the vacuum furnace was sufficiently reduced. Substance E was heated at 135° C. in vacuum for 1 hour and further heated at 170° C. for 10 hours. The obtained substance is referred to as Substance F. Substance F was obtained by performing chemical reduction and thermal reduction on a graphene oxide-including substance in this order. Substance F is referred to as Sample 4.

An example of forming a sample by another method will be described below. Graphene oxide was synthesized by a Modified Hummers method, dried, and pulverized. Then, baking was performed at 170° C. in vacuum for 10 hours as in the above-described method to obtain Substance G. Substance G was obtained by performing thermal reduction on a graphene oxide-including substance. Substance G is referred to as Sample 5 (a comparative example: a sample obtained by thermal reduction).

Substance E (this substance was subjected to thermal reduction later to form Sample 4) was obtained by performing chemical reduction on a graphene oxide-including substance. Substance E is referred to as Sample 6 (a comparative example: a sample obtained by chemical reduction). Substance A (this substance was subjected to chemical reduction and thermal reduction later to form Sample 4) included graphene oxide. Substance A is referred to as Reference Sample 1 (a reference example: a sample before reduction).

### (XPS Analysis)

Measurement of the compositions and the proportions of the carbon binding states based on the chemical shift amount of a 1 s orbital of carbon of Samples 4 to 6 and Reference Sample 1 prepared in the above manner was carried out by X-ray Photoelectron Spectroscopy (XPS). For XPS analysis, QuanteraSXM manufactured by ULVAC-PHI, INCORPORATED having a monochromatic Al X-ray source (1486.6 eV) was used as an X-ray source. Table 4 and Table 5 show analysis results.

TABLE 4

| Sample | C | O | S | Others | C/O |
|---|---|---|---|---|---|
| Reference Sample 1 | 64.1 | 34.0 | 1.3 | 0.6 | 1.89 |
| Sample 4 | 91.0 | 7.9 | — | 1.1 | 11.52 |
| Sample 5 | 82.9 | 16.4 | 0.7 | — | 5.05 |
| Sample 6 | 88.5 | 11.5 | — | — | 7.70 |

Unit: atomic %

TABLE 5

| Sample | C═C | C—C, C—H | C—O | CO═O | O═C—O |
|---|---|---|---|---|---|
| Reference Sample 1 | — | 37.0 | 51.4 | 8.3 | 3.3 |
| Sample 4 | 77.3 | 13.8 | 5.2 | 2.4 | 1.3 |
| Sample 5 | 60.6 | 22.1 | 8.9 | 3.9 | 4.5 |
| Sample 6 | 74.6 | 11.8 | 8.1 | 3.8 | 1.7 |

Unit: %

Table 4 shows XPS analysis results of the compositions of the samples. The proportions (at. %) of carbon (C), oxygen (O), sulfur (S), and the other elements of the samples are shown. In the rightmost columns, the atomic ratios of carbon atoms to oxygen atoms (C/O) are shown. Sample 4 has a greater C/O than Reference Sample 1 not subjected to reduction treatment, Sample 5 obtained by only thermal reduction, and Sample 6 obtained by only chemical reduction, which suggests the reduction reaction of Sample 4.

In addition, the proportion of sp² C═C bonds in Sample 4 is the highest in the atomic proportions of the carbon binding states based on the chemical shift amount of a 1 s orbital of carbon as shown in Table 5.

The XPS analysis results were similar to those in Example 1. They demonstrates that chemical reduction and thermal reduction performed in this order further promotes reduction.

### Example 3

In this example, the characteristics of an electrode fabricated by the method for fabricating an electrode for a power storage device of one embodiment of the present invention are compared with the characteristics of electrodes fabricated without employing the method of one embodiment of the present invention.

### (Fabricating Method of Electrode)

Graphene oxide was added to LiFePO₄, NMP as a solvent was added to the mixture, and kneading was performed. After an NMP solution of PVDF (No. 1100 manufactured by KUREHA CORPORATION) was added as a binder solution to the mixture of graphene oxide and LiFePO₄, NMP was further added as a polar solvent and mixing was performed to form slurry. A planetary centrifugal mixer (“THINKY MIXER” manufactured by THINKY CORPORATION) was used. Finally, the ratio of LiFePO₄:graphene oxide:PVDF in the slurry was 94.4 wt %:0.6 wt %:5 wt %. The slurry formed by the above method was applied to a current collector and dried at 80° C. in the air, so that an electrode where an active material layer was formed over the current collector was formed. This electrode is referred to as Electrode A. Electrode A includes a graphene oxide-including active material layer. As a current collector, 20-μm-thick aluminum coated with approximately 1-μm-thick carbon black was used. The active material content was approximately 9 mg/cm².

Electrode A was soaked in a mixed solution containing Mixed Solvent 1, 13.5 g/L of 77 mmol/L L-ascorbic acid, and 75 mmol/L lithium hydroxide and they were reacted with each other in a hot-water bath at 60° C. for 1 hour, so that the graphene oxide was reduced. That is to say, the graphene oxide was reduced by chemical reduction. Here, monohydrate with a purity of 99% (produced by Kishida Chemical Co., Ltd.) was used as lithium hydroxide. Then, the electrode was soaked in ethanol to be washed. The resulting electrode is referred to as Electrode B.

The graphene oxide was reduced while Electrode B was dried at 170° C. in vacuum for 10 hours. Then, pressing was performed to obtain Electrode C. Electrode C includes an active material layer obtained by performing chemical reduction and thermal reduction on a graphene oxide-including active material layer in this order. Electrode C is referred to as Electrode 1.

Other methods for forming samples will be described below. The graphene oxide was reduced while Electrode A was dried at 170° C. in vacuum for 10 hours. The resulting electrode is referred to as Electrode D. Electrode D includes an active material layer obtained by performing thermal reduction on a graphene oxide-including active material layer. Electrode D is referred to as Electrode 2 (a comparative example: an electrode prepared by thermal reduction).

Electrode B (this electrode was subjected to thermal reduction later to form Electrode 1) was dried at 70° C. in vacuum for 10 hours and then pressed. The resulting electrode is referred to as Electrode E. Electrode E includes an active material layer obtained by performing chemical reduction on a graphene-oxide-including active material layer. Electrode E is referred to as Electrode 3 (a comparative example: an electrode prepared by chemical reduction).

Electrodes 1 to 3 fabricated in the aforementioned manner were each stamped into a disc shape with a diameter of 16 mm, so that Measurement Electrodes 1 to 3 were fabricated.

### (Measurement of Resistivities)

The resistivities of Measurement Electrodes 1 to 3 fabricated in such a manner were measured using a constant current application-type resistivity meters. As the resistivity meter, Loresta GP with BSP-type probes (manufactured by Mitsubishi Chemical Analytech, Co., Ltd.) was used. The BSP-type probes enable resistivity measurement by a four-point probe method, and each of two probes has two terminals. The measurement method will be described below.

Aluminum foil was put on a measurement stand, and each measurement electrode was put thereon such that the active material layer turned up, in other words, such that the current collector side was on the aluminum foil. The measurement of the resistivity of the electrode layer in the thickness direction was performed in the state where one probe was pressed against the center of the active material layer side and the other probe was pressed against the aluminum foil in contact with the current collector. Note that measurement points were sufficiently away from ends. The measurement was performed while the two terminals of each probe were on the measurement electrode or on the aluminum foil.

The resistivities were calculated from the resistance values obtained by the measurement. The calculation formula is expressed as Formula 1.

### [Formula 1]

Resistivity=(resistance value×electrode area)÷electrode layer thickness

Table 6 shows the calculated resistivities.

TABLE 6

| Measured electrode | Resistivity [Ω · cm] |
|---|---|
| Measured electrode 1 | 1.8E+01 |
| Measured electrode 2 | 7.0E+07 |
| Measured electrode 3 | 7.5E+04 |

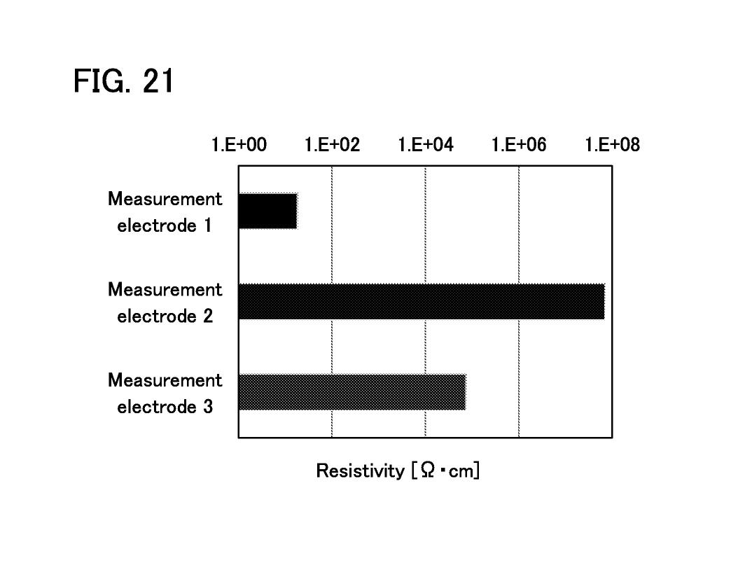

FIG. 21 is a graph visually showing the results in Table 6. Table 6 and FIG. 21 show measurement results of the resistivities of the measurement electrodes. The resistivities of the measurement electrodes are logarithmically expressed. The resistivity of Measurement Electrode 3 obtained by performing only chemical reduction was significantly lower than that of Measurement Electrode 2 obtained by performing only thermal reduction.

Thermal reduction of graphene oxide is accompanied by decarboxylation, so that a carbon atom in a graphene honeycomb structure is released. This causes damage to the structure of graphene oxide thermally reduced; thus, the thermally reduced graphene oxide is unlikely to have the inherent conductivity of graphene.

In contrast, a reaction mechanism of a reduction reaction of graphene oxide with the use of L-ascorbic acid can be presumably expressed by Chemical Formula (B-1) or Chemical Formula (B-2), for example. Note that the reaction of the graphene oxide at an end portion thereof is shown for simplification; the reaction inside the graphene oxide is similar to that at the end portion thereof because steric hindrance is less likely to occur. A carbonyl group and an epoxy group also exist as functional groups of graphene oxide; however, a portion containing many hydroxy groups is shown as an example, here.

Chemical Formula (B-1) expresses a reaction mechanism in which L-ascorbic acid provides a proton to graphene oxide such that graphene is formed. Graphene oxide to which a proton is added is dehydrated, so that graphene is formed. Note that the reaction velocity depends on a reaction solvent; the reaction velocity in the case of using alcohol as a reaction solvent is higher than that in the case of using an aprotic solvent and the reaction velocity in the case of using water as a reaction solvent is higher than that in the case of using alcohol. Thus, the above reaction mechanism is suggested.

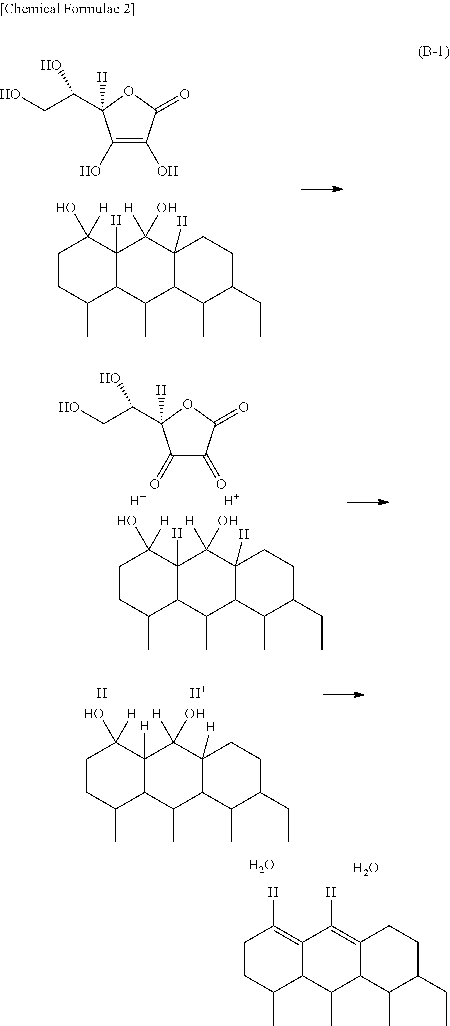

Equation (B-2) expresses a reaction mechanism in which L-ascorbic acid is added to graphene oxide to form a composite and then dihydroascorbic acid is released from the formed composite, so that graphene is formed.

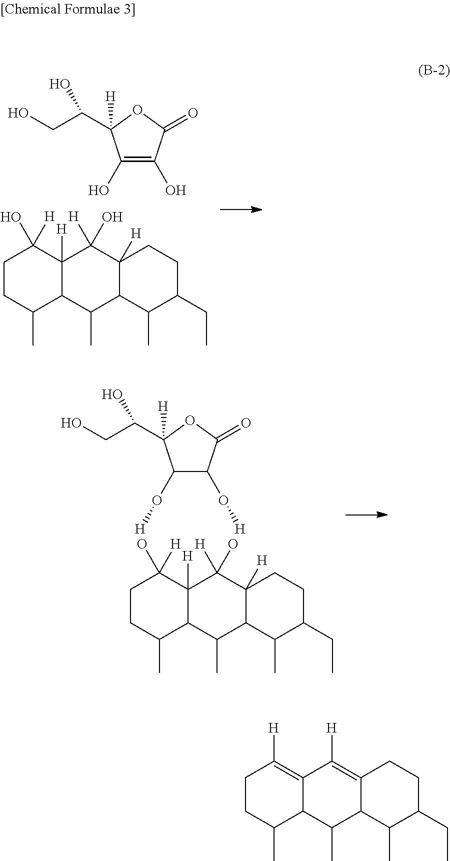

The reaction mechanism where L-ascorbic acid reduces graphene oxide to form graphene is expressed by Chemical Formulae (B-1) or (B-2) showing that the graphene honeycomb structure is not damaged unlike in the case of thermal reduction. This may be the reason why the resistivity of Measurement Electrode 3 was lower than that of Measurement Electrode 2.

In addition, the resistivity of Measurement Electrode 1 obtained by performing chemical reduction and thermal reduction was lower than that of Measurement Electrode 3 obtained by performing only chemical reduction. This implies that thermal reduction occurred even after chemical reduction. This is also suggested by the XPS analysis results in Example 1.

The conductivity in the electrode was significantly reduced presumably because thermal reduction was performed on a portion where reduction was not completed only by chemical reduction.

### Example 4

In this example, the characteristics of a power storage device fabricated using the electrode of one embodiment of the present invention are compared with the characteristics of a power storage device fabricated without using the electrode of one embodiment of the present invention.

### (Fabricating Methods of Power Storage Devices)

Electrode 1 fabricated in Example 3 was stamped into a disc shape with a diameter of 12 mm and used as a positive electrode in fabricating a 2032-type coin-cell battery. This coin-cell battery is referred to as Power Storage Device B1. Power Storage Device B1 includes Electrode 1. Electrode 1 includes the active material layer obtained by performing chemical reduction and thermal reduction on the graphene oxide-including active material layer in this order.

In Power Storage Device B1, polypropylene (PP) was used as a separator; a lithium metal was used for a negative electrode; and an electrolytic solution formed in such a manner that lithium hexafluorophosphate (LiPF₆) was dissolved at a concentration of 1 mol/L in a mixed solution of ethylene carbonate (EC) and diethyl carbonate (DEC) mixed at a volume ratio of 1:1 was used. Note that the active material content in the positive electrode was 8 mg/cm² to 9 mg/cm², inclusive.

Examples of fabricating power storage devices using electrodes fabricated by other methods will be described below. Electrode 2 fabricated in Example 3 was stamped into a disc shape with a diameter of 12 mm and used as a positive electrode in fabricating a 2032-type coin-cell battery. This coin-cell battery is referred to as Power Storage Device B2 (a comparative example: a power storage device obtained by performing thermal reduction). Power Storage Device B2 includes Electrode 2. Electrode 2 was fabricated using the graphene oxide-including active material layer in such a manner that heat treatment was performed at 170° C. for 10 hours to thermally reduce the graphene oxide. That is, Electrode 2 includes the active material layer obtained by performing thermal reduction on the graphene oxide-including active material layer. Materials of components except the positive electrode in Power Storage Device B2 were the same as those in Power Storage Device B1. Note that the active material content in the positive electrode was 8 mg/cm² to 9 mg/cm², inclusive.

Electrode 3 fabricated in Example 3 was stamped into a disc shape with a diameter of 12 mm and used as a positive electrode in fabricating a 2032-type coin-cell battery. This coin-cell battery is referred to as Power Storage Device B3 (a comparative example: a power storage device obtained by performing chemical reduction). Power Storage Device B3 includes Electrode 3. Electrode 3 was fabricated using the graphene oxide-including active material layer in such a manner that the active material layer was soaked in a mixed solution containing L-ascorbic acid as a reducing agent and lithium hydroxide and they are reacted with each other in a hot-water bath at 60° C. for 1 hour so that the graphene oxide was chemically reduced. That is, Electrode 3 includes the active material layer obtained by performing chemical reduction on the graphene oxide-including active material layer. Materials of components except the positive electrode in Power Storage Device B3 were the same as those in Power Storage Device B1. Note that the active material content in the positive electrode was 8 mg/cm² to 9 mg/cm², inclusive.

### (Discharge Characteristics of Power Storage Devices)

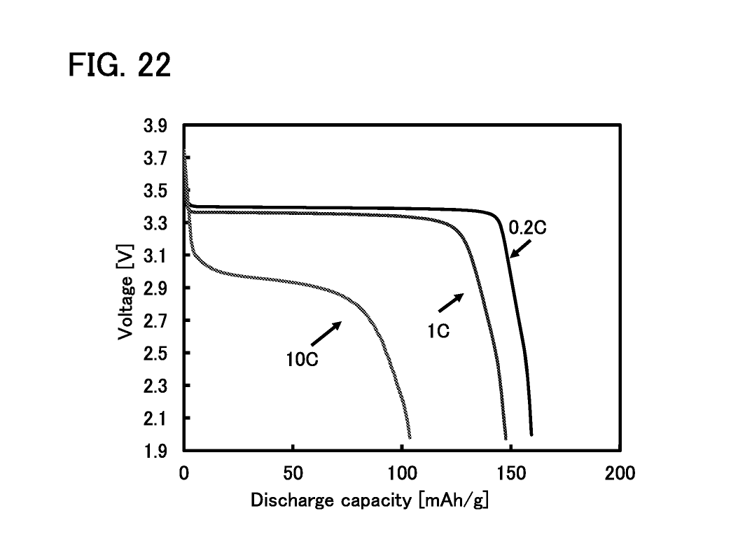

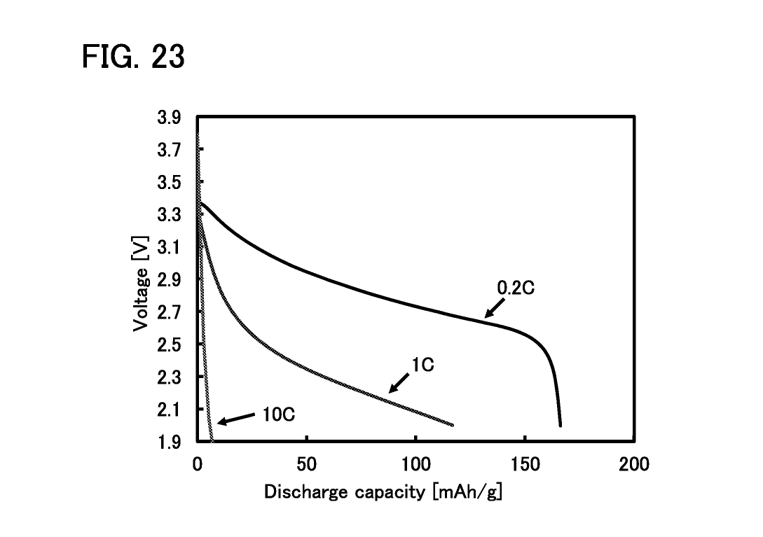

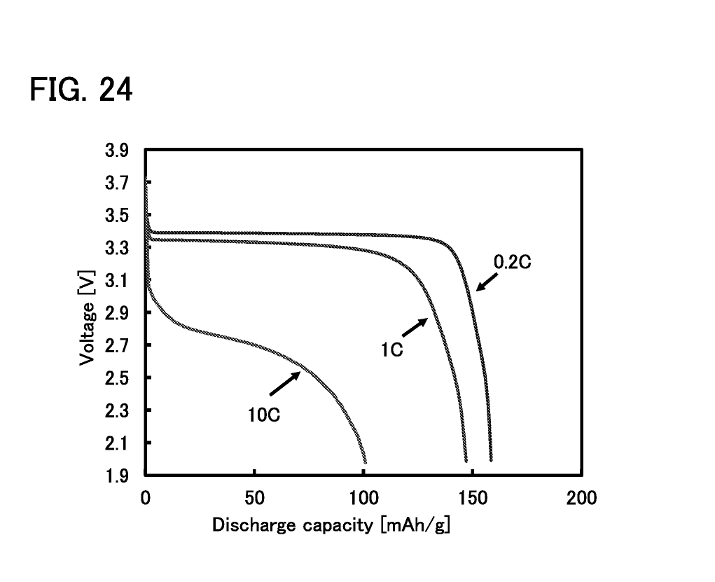

FIG. 22, FIG. 23, and FIG. 24 show the discharge characteristics of Power Storage Device B1, Power Storage Device B2, and Power Storage Device B3, respectively, each of which was measured at three discharge rates at constant current.

FIG. 22 is a graph showing the discharge characteristics of Power Storage Device B1, where the horizontal axis represents discharge capacity (mAh/g) and the vertical axis represents voltage (V). FIG. 22 shows three discharge curves of different discharge rates. A charge and discharge rate C refers to the rate at which a power storage device is charged and discharged and is represented by “current (A)÷capacity (Ah)”. For example, the charge and discharge rate in the case of charging and discharging a power storage device having a capacity of 1 Ah with 1 A is 1 C, and the charge and discharge rate in the case of charging and discharging the battery with 10 A is 10 C. The discharge rates for the measurement were 0.2 C (discharging is ended in exactly 5 hours), 1 C, and 10 C.

FIG. 23 is a graph showing the discharge characteristics of Power Storage Device B2, where the horizontal axis represents discharge capacity (mAh/g) and the vertical axis represents voltage (V). Like in the case of Power Storage Device B1, the discharge rates for the measurement were 0.2 C (discharging is ended in exactly 5 hours), 1 C, and 10 C.

FIG. 24 is a graph showing the discharge characteristics of Power Storage Device B3, where the horizontal axis represents discharge capacity (mAh/g) and the vertical axis represents voltage (V). Like in the cases of Power Storage Devices B1 and B2, the discharge rates for the measurement were 0.2 C (discharging is ended in exactly 5 hours), 1 C, and 10 C.

First, FIG. 22 shows the discharge characteristics of Power Storage Device B1 including an electrode for a power storage device that was formed by the fabricating method of one embodiment of the present invention. As shown in FIG. 22, in the case where the discharge rate was 0.2 C, the plateau (flat potential region) potential was as high as approximately 3.4 V, and was maintained until when the discharge capacity exceeded 100 mAh/g. In addition, a high discharge capacity of approximately 160 mAh/g was observed. This result is very close to that of Power Storage Device B3 described later, and the results obtained in the cases where the discharge rates were 1 C and 10 C were also very close to those of Power Storage Device B3.

Next, FIG. 23 shows the discharge characteristics of Power Storage Device B2. As shown in FIG. 23, the discharge potential of Power Storage Device B2 was low at any discharge rate and the discharge curves do not have plateau regions. However, a high discharge capacity of approximately 160 mAh/g was observed.

Next, the discharge characteristics of Power Storage Device B3 will be described with reference to FIG. 24. As shown in FIG. 24, the curve of Power Storage Device B3 discharged at a rate of 0.2 C has a high plateau potential of approximately 3.4 V and the plateau was maintained until when the discharge capacity exceeded 100 mAh/g. In addition, a high discharge capacity of approximately 160 mAh/g was observed.

### (Charge and Discharge Cycle Characteristics of Power Storage Devices)

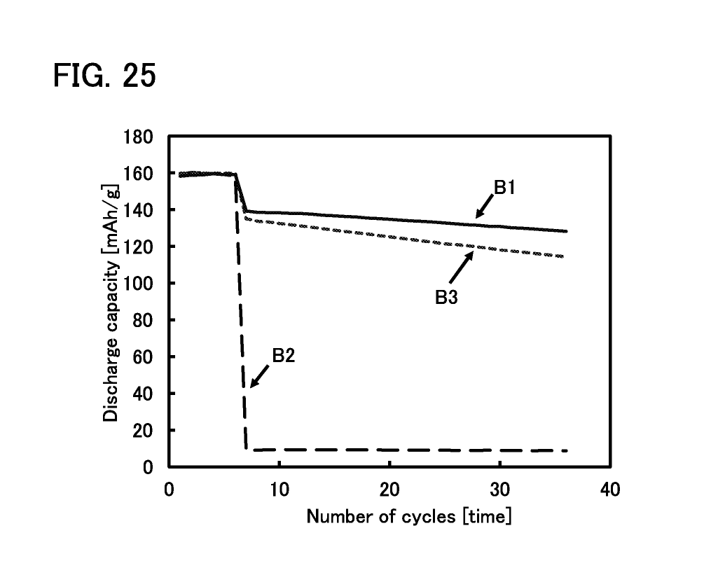

FIG. 25 shows the charge and discharge cycle characteristics of Power Storage Devices B1 to B3 measured at constant current. The horizontal axis represents the number of cycles (the number of repeated charges and discharges) and the vertical axis represents discharge capacity (mAh/g). The charge and discharge rates for measurement of the charge and discharge characteristics were 0.2 C in the first six cycles and 1 C in the subsequent cycles. A solid line, a broken line 1, and a broken line 2 represent the charge and discharge cycle characteristics of Power Storage Device B1, that of Power Storage Device B2, and that of Power Storage Device B3, respectively.

The discharge capacities of Power Storage devices B1 to B3 when charge and discharge were performed at 0.2 C (in the first six cycles) are substantially equal to one another.

In contrast, the discharge capacity of Power Storage Device B1 after charges and discharges performed at 1 C is higher than those of Power Storage Devices B2 and B3. The discharge capacities of Power Storage Devices B1 and B3 are gradually reduced as charges and discharges are repeated. The slope of decrease in discharge capacity of Power Storage Device B1 with respect to the number of cycles is smaller than that of Power Storage device B3. That is, Power Storage Device B1 retains higher discharge capacity than Power Storage Device B3.

Specifically, Power Storage Device B1 obtained by performing chemical reduction and thermal reduction achieved more excellent cycle characteristics than Power Storage Device B2 obtained by performing only thermal reduction and Power storage device B3 obtained by performing only chemical reduction.

### Comparative Examples

Examples of fabricating power storage devices using electrodes fabricated by other methods will be described below.

### (Fabricating Methods of Electrodes)

Graphene oxide was added to LiFePO₄, NMP (produced by Tokyo Chemical Industry Co., Ltd.) was added as a solvent to the mixture, and kneading (in a highly viscous state) was performed. After an NMP solution of PVDF (No. 7300 manufactured by KUREHA CORPORATION) was added as a binder solution to the mixture of graphene oxide and LiFePO₄, NMP was further added as a polar solvent and mixing was performed to form slurry. The slurry formed by the above method was applied to a current collector and dried at 80° C. in the air for 40 minutes, so that an electrode where an active material layer was formed over the current collector was formed. This electrode is referred to as Electrode J. Finally, the compounding ratio of LiFePO₄:graphene oxide:PVDF was 93 wt %:2 wt %:5 wt %.

As a current collector, 20-μm-thick aluminum coated with approximately 1-μm-thick carbon black was used.

Next, Electrode J was reacted with L-ascorbic acid at 60° C. for 4.5 hours. The resulting electrode is referred to as Electrode K. Another Electrode J was heated at 170° C. in vacuum for 10 hours. The resulting electrode is referred to as Electrode L. Another Electrode J was heated at 170° C. in vacuum for 10 hours and then reacted with L-ascorbic acid at 60° C. for 3.0 hours. The resulting electrode is referred to as Electrode M. Another Electrode J was heated at 170° C. in vacuum for 10 hours and then reacted with L-ascorbic acid at 60° C. for 4.5 hours. The resulting electrode is referred to as Electrode N. Note that Electrode J includes a graphene oxide-including active material layer. Electrode K includes a graphene-including active material layer obtained by performing chemical reduction on a graphene oxide-including active material layer. Electrode L includes a graphene-including active material layer obtained by performing thermal reduction on a graphene oxide-including active material layer. Electrodes M and N each include a graphene-including active material layer obtained in such a manner that a graphene oxide-including active material layer was subjected to thermal reduction and then soaked in an L-ascorbic acid solution.

Note that the reaction with L-ascorbic acid was performed in such a manner that the electrode was soaked in an ethanol solution containing 77 mmol/L L-ascorbic acid at a predetermined temperature for a predetermined time, washed with ethanol, and then dried by air drying and 10-hour vacuum drying at 100° C. Note that L-ascorbic acid with a purity of 99.6% produced by Wako Pure Chemical Industries, Ltd. was used.

Electrodes fabricated by methods different from those of the above electrodes will be described below. A current collector was formed in such a manner that a mixture of graphite and sodium polyacrylate was applied to aluminum foil and then heating was performed at 170° C. in vacuum for 10 hours. Slurry was applied to the current collector and dried as in the case of Electrode J, so that Electrode O in which an active material layer was formed over the current collector was fabricated. Electrode O was soaked in an aqueous solution containing 77 mmol/L L-ascorbic acid and 73 mmol/L lithium hydroxide at 60° C. for 1.0 hour, washed with ethanol, and then dried at 100° C. in vacuum for 10 hours. The resulting electrode is referred to as Electrode P. Note that the current collector was heated before the application of the slurry to prevent dissolution of a carbon layer in the aqueous solution and separation of the electrode layer from the current collector. Electrode O includes a graphene oxide-including active material layer. Electrode P includes a graphene-including active material layer obtained by performing chemical reduction on a graphene oxide-including active material layer.

### (Fabricating Methods of Power Storage Devices)

Electrode K was pressed and then stamped into a disc shape with a diameter of 12 mm and used as a positive electrode in fabricating a 2032-type coin-cell battery. This coin-cell battery is referred to as Power Storage Device B5 (a comparative example). In Power Storage Device B5, a lithium metal was used for a negative electrode; an electrolytic solution formed in such a manner that lithium hexafluorophosphate (LiPF₆) was dissolved at a concentration of 1 mol/L in a mixed solution of ethylene carbonate (EC) and diethyl carbonate (DEC) mixed at a volume ratio of 1:1 was used; and porous polypropylene (PP) was used as a separator.

A coin-cell battery fabricated in a similar manner using Electrode L is referred to as Power Storage Device B6 (a comparative example). A coin-cell battery fabricated in a similar manner using Electrode M is referred to as Power Storage Device B7 (a comparative example). A coin-cell battery fabricated in a similar manner using Electrode N is referred to as Power Storage Device B8 (a comparative example). A coin-cell battery fabricated in a similar manner using Electrode P is referred to as Power Storage Device B9 (a comparative example).

Here, in Power Storage Device B5, the active material content in the positive electrode was 6.8 mg/cm², and the thickness of the active material layer was 43 μm. The active material content in the positive electrode of Power Storage Device B6 was 5.9 mg/cm², and the thickness of the active material layer was 41 μm. The active material content in the positive electrode of Power Storage Device B7 was 5.7 mg/cm², and the thickness of the active material layer was 32 μm. The active material content in the positive electrode of Power Storage Device B8 was 5.9 mg/cm², and the thickness of the active material layer was 33 μm. The active material content in the positive electrode of Power Storage Device B9 was 6.7 mg/cm², and the thickness of the active material layer was 44 μm. Note that the active material content was calculated to be 93% of the measured weight of the active material layer, and the changes in the weight of graphene components were left out of view.

### (Discharge Characteristics of Power Storage Devices)

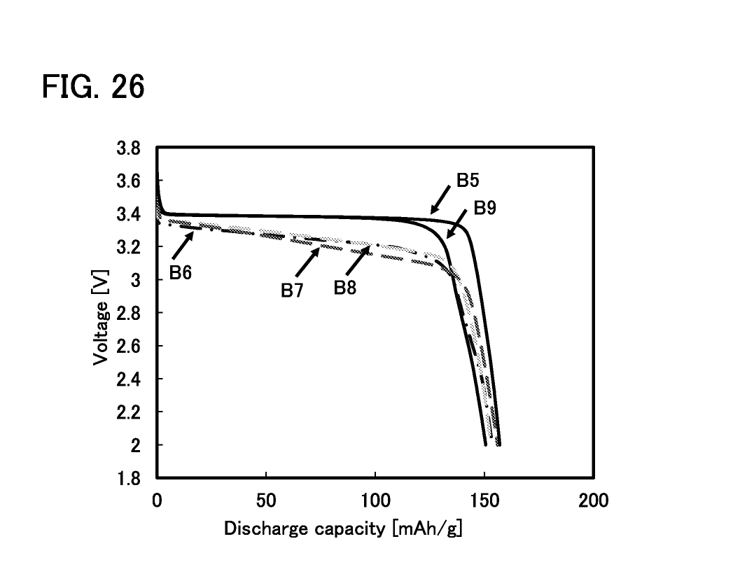

The discharge characteristics of the obtained Power Storage Devices B5 to B9 were measured. Charge was performed by CCCV, specifically, in such a manner that a voltage was applied at a constant current of 0.2 C until the voltage reached 4.3 V and then a constant voltage of 4.3 V was maintained until the current value reached 0.05 C. Discharge was performed by CC, specifically, in such a manner that a voltage was applied at a constant current of 0.2 C until the voltage reached 2.0 V. FIG. 26 shows the discharge curves in the first cycle.

It is found from the slopes of plateaus (flat potential regions) of the discharge curves in FIG. 26 that the discharge characteristics of Power Storage Devices 5 and 9 each including the active material layer obtained by performing chemical reduction on a graphene oxide-including active material layer are better than those of Power Storage Device 6 obtained by performing thermal reduction on a graphene oxide-including active material layer. This result suggests that graphene obtained by chemical reduction has higher electric conductivity than graphene obtained by thermal reduction. It is also found from the slopes of the discharge curves that the characteristics of Power Storage Devices 7 and 8 each obtained in such a manner that a graphene oxide-including active material layer was subjected to thermal reduction and then soaked in an L-ascorbic acid solution are substantially equal to those of Power Storage Device 6 obtained by performing thermal reduction on a graphene oxide-including active material layer. This result implies that although the active material layer of each of Power Storage Devices 7 and 8 was soaked in an L-ascorbic acid solution after heat application, there was substantially no effect and chemical reduction hardly occurred. Graphene obtained by thermal reduction was probably less likely to be chemically reacted.

### Example 5

An example of using an active material layer including graphene oxide and a carbon-coated active material in an electrode for the power storage device of one embodiment of the present invention will be described in this example.

### (Fabricating Method of Electrode)

Note that LiPO₄ coated with carbon in a stage of solid phase synthesis of LiFePO₄ with the use of a raw material to which glucose was added was used as LiFePO₄. Graphene oxide was added to the carbon-coated LiFePO₄, NMP as a solvent was added to the mixture, and kneading was performed. After an NMP solution of PVDF (No. 7300 manufactured by KUREHA CORPORATION) was added as a binder solution to the mixture of the graphene oxide and the carbon-coated LiFePO₄, NMP was further added as a polar solvent and mixing was performed to form slurry. Finally, the ratio of LiFePO₄ (coated with carbon):graphene oxide:PVDF was 94.2 wt %:0.8 wt %:5 wt %. The slurry formed by the above method was applied to a current collector and dried at 80° C. in the air for 2 minutes, so that an electrode where an active material layer was formed over the current collector was formed. This electrode is referred to as Electrode F. Electrode F includes a graphene oxide-including active material layer. The current collector was formed in such a manner that 20-μm-thick aluminum was coated with approximately 1-μm-thick graphite by a doctor blade method. The active material content was approximately 11 mg/cm².

Electrode F was soaked in a mixed solution containing Mixed Solvent 1, 13.5 g/L of 77 mmol/L L-ascorbic acid, and 75 mmol/L lithium hydroxide and they were reacted with each other in a hot-water bath at 60° C. for 1 hour, so that the graphene oxide was reduced. That is to say, the graphene oxide was reduced by chemical reduction. Then, the electrode was soaked in ethanol to be washed. The resulting electrode is referred to as Electrode G.

The graphene oxide was reduced while Electrode G was dried at 170° C. in vacuum for 10 hours. Then, pressing was performed to obtain Electrode H. Electrode H includes an active material layer obtained by performing chemical reduction and thermal reduction on a graphene oxide-including active material layer in this order. Electrode H is referred to as Electrode 4.

Electrode 4 fabricated in the aforementioned manner was stamped into a disc shape with a diameter of 16 mm, so that Measurement Electrode 4 was fabricated.

### (Measurement of Resistivity)

The resistivity of Measurement Electrode 4 fabricated in such a manner was measured using a constant current application-type resistivity meter. The measurement method of resistance and the calculating method of electric resistivity were the same as those in Example 3.

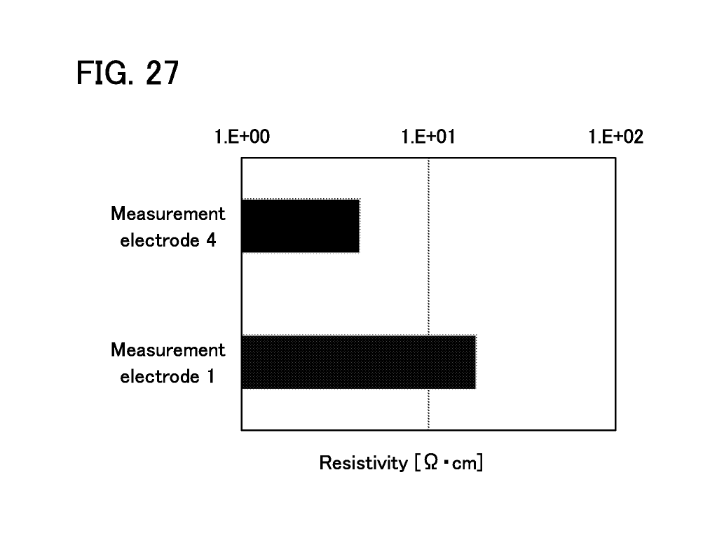

Table 7 and FIG. 27 show the obtained electric resistivity of Measurement Electrode 4 and the resistivity of Measurement Electrode 1 fabricated in Example 3 for comparison. Measurement Electrode 4 of this example includes a carbon-coated active material and an active material layer obtained by performing chemical reduction and thermal reduction on a graphene oxide-including active material layer in this order. In contrast, Measurement Electrode 1 includes an active material not coated with carbon and an active material layer obtained by performing chemical reduction and thermal reduction on a graphene oxide-including active material layer in this order. FIG. 27 is a graph visually showing the results in Table 7.

TABLE 7

| Measured electrode | Resistivity [Ω · cm] |
|---|---|
| Measured electrode 4 | 4.3E+00 |
| Measured electrode 1 | 1.8E+01 |

As shown in Table 7 and FIG. 27, Measurement Electrode 4 of this example including a carbon-coated active material has lower electric resistivity than Measurement Electrode 1 including an active material not coated with carbon. That is to say, the use of the active material layer including graphene oxide and a carbon-coated active material in the electrode for the power storage device of one embodiment of the present invention further increased conductivity.

This application is based on Japanese Patent Application serial no. 2013-261276 filed with the Japan Patent Office on Dec. 18, 2013, the entire contents of which are hereby incorporated by reference.

What is claimed is:

1. Graphene comprising:
carbon atoms whose proportion measured by X-ray photoelectron spectroscopy is greater than or equal to 90 at. % and less than 98 at. %; and
oxygen atoms whose proportion measured by X-ray photoelectron spectroscopy is greater than or equal to 2 at. % and less than 10 at. %,
wherein a proportion of sp²-bonded carbon atoms of the carbon atoms measured by X-ray photoelectron spectroscopy is greater than or equal to 50% and less than or equal to 80%.

2. The graphene according to claim 1, wherein a resistivity of the graphene is 2.0×10⁻² Ω·cm or less.

3. An electrode comprising:
a current collector; and
an active material layer including graphene and active material particles,
wherein the graphene comprising:
carbon atoms whose proportion measured by X-ray photoelectron spectroscopy is greater than or equal to 90 at. % and less than 98 at. %; and
oxygen atoms whose proportion measured by X-ray photoelectron spectroscopy is greater than or equal to 2 at. % and less than 10 at. %, and
wherein a proportion of sp²-bonded carbon atoms of the carbon atoms measured by X-ray photoelectron spectroscopy is greater than or equal to 50% and less than or equal to 80%.

4. The electrode according to claim 3, wherein a resistivity of the graphene is 2.0×10⁻² Ω·cm or less.

5. The electrode according to claim 3, wherein the active material particles include lithium.

6. The electrode according to claim 3, wherein the active material particles are lithium metal phosphate compounds.

7. A power storage device comprising the electrode according to claim 3 as at least one of a positive electrode and a negative electrode.

8. A method for forming graphene, comprising the steps of:
forming slurry containing graphene oxide;
forming a layer including the graphene oxide using the slurry;
performing chemical reduction as a first reduction treatment on the graphene oxide in the layer; and
performing thermal reduction as a second reduction treatment on the graphene oxide in the layer after the first reduction treatment, whereby graphene is formed.

9. The method for forming graphene, according to claim 8,
wherein the graphene comprising:
carbon atoms whose proportion measured by X-ray photoelectron spectroscopy is greater than or equal to 90 at. % and less than 98 at. %; and
oxygen atoms whose proportion measured by X-ray photoelectron spectroscopy is greater than or equal to 2 at. % and less than 10 at. %, and
wherein a proportion of sp²-bonded carbon atoms of the carbon atoms measured by X-ray photoelectron spectroscopy is greater than or equal to 50% and less than or equal to 80%.

10. A method for forming an electrode, comprising the steps of:
forming slurry containing graphene oxide and active material particles;
forming a layer including the graphene oxide and the active material particles over a current collector using the slurry;
performing chemical reduction as a first reduction treatment on the graphene oxide in the layer; and
performing thermal reduction as a second reduction treatment on the graphene oxide in the layer after the first reduction treatment, whereby an electrode including graphene is formed.

11. The method for forming an electrode, according to claim 10,
wherein the graphene comprising:
carbon atoms whose proportion measured by X-ray photoelectron spectroscopy is greater than or equal to 90 at. % and less than 98 at. %; and
oxygen atoms whose proportion measured by X-ray photoelectron spectroscopy is greater than or equal to 2 at. % and less than 10 at. %, and
wherein a proportion of sp²-bonded carbon atoms of the carbon atoms measured by X-ray photoelectron spectroscopy is greater than or equal to 50% and less than or equal to 80%.

12. The method for forming an electrode, according to claim 10, wherein the active material particles include lithium.

13. The method for forming an electrode, according to claim 10, wherein the active material particles are lithium metal phosphate compounds.

14. A method for manufacturing a power storage device, comprising the step of:
forming the electrode according to claim 13 as at least one of a positive electrode and a negative electrode.
